(19) United States
(12) Patent Application Publication
(10) Pub. No.: US 2026/0291829 A1
(43) Pub. Date: Sep. 24, 2026

(54) NETWORK DESIGN FOR SUBSTRATE IN THE OVERLAY

(71) Applicant: Oracle International Corporation, Redwood Shores, CA (US)

(72) Inventors: Abhay Patil, Seattle, WA (US); Bryce Bockman, Seattle, WA (US)

(73) Assignee: Oracle International Corporation, Redwood Shores, CA (US)

(21) Appl. No.: 19/647,753

(22) Filed: Apr. 14, 2026

Related U.S. Application Data
(63) Continuation-in-part of application No. 19/076,158, filed on Mar. 11, 2025.

(51) Int. Cl. H04L 41/40; H04L 12/46

(52) U.S. Cl. CPC H04L 41/40; H04L 12/46; H04L 2212/00

(57) ABSTRACT

A source network virtualization device (NVD) receives a data packet destined for a cloud service accessible via a virtual IP address in a virtual cloud network (VCN). The source NVD encapsulates the data packet with a first encapsulation header to generate a first encapsulated data packet, the first encapsulated data packet being forwarded to a dynamic routing gateway (DRG). The DRG encapsulates the first encapsulated data packet with a second encapsulation header to generate a second encapsulated data packet, the second encapsulated data packet being forwarded to destination NVD associated with the cloud service, whereas the destination NVD decapsulates the second encapsulated data packet to obtain the first encapsulated data packet. The destination NVD communicates the first encapsulated data packet to the cloud service, wherein a virtual network interface card (VNIC) associated with the cloud service decapsulates the first encapsulated data packet to obtain the data packet.

### CROSS-REFERENCES TO RELATED APPLICATIONS

This application is a continuation-in-part application of U.S. Non-Provisional application Ser. No. 19/076,158, filed on Mar. 11, 2025, and claims priority to U.S. Provisional Application No. 63/789,249, filed on Apr. 15, 2025, and U.S. Provisional Application No. 63/872,012, filed on Aug. 28, 2025, each of which is incorporated herein by reference in its entirety for all purposes.

### BACKGROUND

Cloud service providers (CSPs) can offer computing infrastructure for customers using resources in several data centers. As cloud computing demand increases, CSPs can improve the availability of cloud resources by scaling the data centers. However, scaling can result in large data center footprints with a significant number of computing devices requiring a commensurate number of resources to operate as well as reserving significant computing resources for the effective management of the cloud resources themselves.

Embodiments discussed herein address these and other issues individually as well as collectively.

### SUMMARY

The present disclosure relates to cloud computing networks. More particularly, the present disclosure describes architectures, infrastructure, and related techniques for implementing a reduced footprint data center. Embodiments discussed herein provide for networking capabilities with respect to the reduced footprint data center. Specifically, according to different embodiments of the present disclosure, there is provided a new architecture for a region in which an initial network footprint of the data center is as small as feasible, while still providing core CSP services and scalability for customer demands. In the new architecture, services that are typically provided in a region (e.g., Block Storage, Object Storage, Identity) are shifted/moved from being provided in a substrate layer (i.e., an underlay network layer or the physical network layer) into an overlay network layer. In doing so, it is noted that the region will not have dedicated hosts for the substrate network but will require particular solutions for connectivity with the substrate services that are now being offered in the overlay. This disclosure outlines a customer model for the new framework of services provided in the overlay and describes the different types of routing mechanisms that will be employed in the framework. Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the detailed description section, and further description is provided therein.

One embodiment of the present disclosure is directed to a method comprising: receiving, at a source network virtualization device (NVD), a data packet destined for a cloud service accessible via a virtual IP address in a virtual cloud network (VCN); encapsulating, by the source NVD, the data packet with a first encapsulation header to generate a first encapsulated data packet, the first encapsulated data packet being forwarded to a dynamic routing gateway (DRG); encapsulating, by the DRG, the first encapsulated data packet with a second encapsulation header to generate a second encapsulated data packet, the second encapsulated data packet being forwarded to destination NVD associated with the cloud service; decapsulating, by the destination NVD, the second encapsulated data packet to obtain the first encapsulated data packet; and communicating, by the destination NVD, the first encapsulated data packet to the cloud service, wherein a virtual network interface card (VNIC) associated with the cloud service decapsulates the first encapsulated data packet to obtain the data packet.

Another aspect of the present disclosure provides for a non-transitory computer readable medium storing specific computer-executable instructions that, when executed by a processor, cause a computer system to perform operations comprising: receiving, at a source network virtualization device (NVD), a data packet destined for a cloud service accessible via a virtual IP address in a virtual cloud network (VCN); encapsulating, by the source NVD, the data packet with a first encapsulation header to generate a first encapsulated data packet, the first encapsulated data packet being forwarded to a dynamic routing gateway (DRG); encapsulating, by the DRG, the first encapsulated data packet with a second encapsulation header to generate a second encapsulated data packet, the second encapsulated data packet being forwarded to destination NVD associated with the cloud service; decapsulating, by the destination NVD, the second encapsulated data packet to obtain the first encapsulated data packet; and communicating, by the destination NVD, the first encapsulated data packet to the cloud service, wherein a virtual network interface card (VNIC) associated with the cloud service decapsulates the first encapsulated data packet to obtain the data packet.

Another aspect of the present disclosure provides for networking system comprising: a processor; and a memory including instructions that, when executed with the processor, cause the networking system to, at least: receive, at a source network virtualization device (NVD), a data packet destined for a cloud service accessible via a virtual IP address in a virtual cloud network (VCN); encapsulate, by the source NVD, the data packet with a first encapsulation header to generate a first encapsulated data packet, the first encapsulated data packet being forwarded to a dynamic routing gateway (DRG); encapsulate, by the DRG, the first encapsulated data packet with a second encapsulation header to generate a second encapsulated data packet, the second encapsulated data packet being forwarded to destination NVD associated with the cloud service; decapsulate, by the destination NVD, the second encapsulated data packet to obtain the first encapsulated data packet; and communicate, by the destination NVD, the first encapsulated data packet to the cloud service, wherein a virtual network interface card (VNIC) associated with the cloud service decapsulates the first encapsulated data packet to obtain the data packet.

The foregoing, together with other features and embodiments will become more apparent upon referring to the following specification, claims, and accompanying drawings.

### BRIEF DESCRIPTION OF THE DRAWINGS

Features, embodiments, and advantages of the present disclosure are better understood when the following Detailed Description is read with reference to the accompanying drawings.

FIG. 1 is a high level diagram of a distributed environment showing a virtual or overlay cloud network hosted by a cloud service provider infrastructure according to certain embodiments.

FIG. 2 depicts a simplified architectural diagram of the physical components in the physical network within CSPI according to certain embodiments.

FIG. 3 shows an example arrangement within CSPI where a host machine is connected to multiple network virtualization devices (NVDs) according to certain embodiments.

FIG. 4 depicts connectivity between a host machine and an NVD for providing I/O virtualization for supporting multitenancy according to certain embodiments.

FIG. 5 depicts a simplified block diagram of a physical network provided by a CSPI according to certain embodiments.

FIG. 6 is a block diagram illustrating an example system architecture of a reduced footprint data center including an initialization device, according to some embodiments.

FIG. 7A is a block diagram illustrating a conventional data center including a plurality of server racks reserved for particular functionality.

FIG. 7B is a block diagram illustrating a reduced footprint data center in which services are in an overlay network, according to some embodiments.

FIG. 8 is a block diagram illustrating the expansion of a reduced footprint data center, according to some embodiments.

FIG. 9 illustrates an exemplary customer model of a reduced footprint data center, according to some embodiments.

FIG. 10A depicts a schematic illustrating routing from a source in an overlay network to a destination in the overlay network, according to some embodiments.

FIG. 10B illustrates a flowchart depicting steps performed by a network virtualization device in executing routing of a packet, according to some embodiments.

FIG. 10C illustrates another schematic illustrating routing performed in an overlay network, according to some embodiments.

FIG. 11A depicts a schematic illustrating routing from a source in an overlay network to a destination in an underlay network, according to some embodiments.

FIG. 11B illustrates a flowchart depicting steps performed by a network virtualization device in executing routing of a packet, according to some embodiments.

FIG. 12 depicts an exemplary schematic architecture 1200 depicting usage of a DRG in achieving network connectivity between different services when migrated to the overlay layer, according to some embodiments.

FIG. 13 depicts another exemplary networking architecture utilizing the DRG to achieve connectivity between a substrate and an overlay network layer, according to certain embodiments.

FIG. 14A depicts an exemplary connection established from a customer's compute instance to a service executed in the overlay layer, according to certain embodiments.

FIG. 14B depicts exemplary packets that are transmitted in the connection established of FIG. 14A.

FIG. 14C illustrates a flowchart depicting steps performed by a network virtualization device in executing routing of a packet, according to some embodiments.

FIG. 15 is a block diagram illustrating one pattern for implementing a cloud infrastructure as a service system, according to at least one embodiment.

FIG. 16 is a block diagram illustrating another pattern for implementing a cloud infrastructure as a service system, according to at least one embodiment.

FIG. 17 is a block diagram illustrating another pattern for implementing a cloud infrastructure as a service system, according to at least one embodiment.

FIG. 18 is a block diagram illustrating another pattern for implementing a cloud infrastructure as a service system, according to at least one embodiment.

FIG. 19 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Example Architecture of Cloud Infrastructure

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The virtual or overlay networks can include one or more virtual cloud networks (VCNs). The virtual networks are implemented using software virtualization technologies (e.g., hypervisors, functions performed by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN-IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual networks. Both the physical IP addresses and overlay IP addresses are types of real IP addresses. These are separate from virtual IP addresses, where a virtual IP address maps to multiple real IP addresses. A virtual IP address provides a 1-to-many mapping between the virtual IP address and multiple real IP addresses.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in a virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC) that enables the compute instance to participate in a subnet of a VCN. A VNIC is a logical representation of physical Network Interface Card (NIC). In general, a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

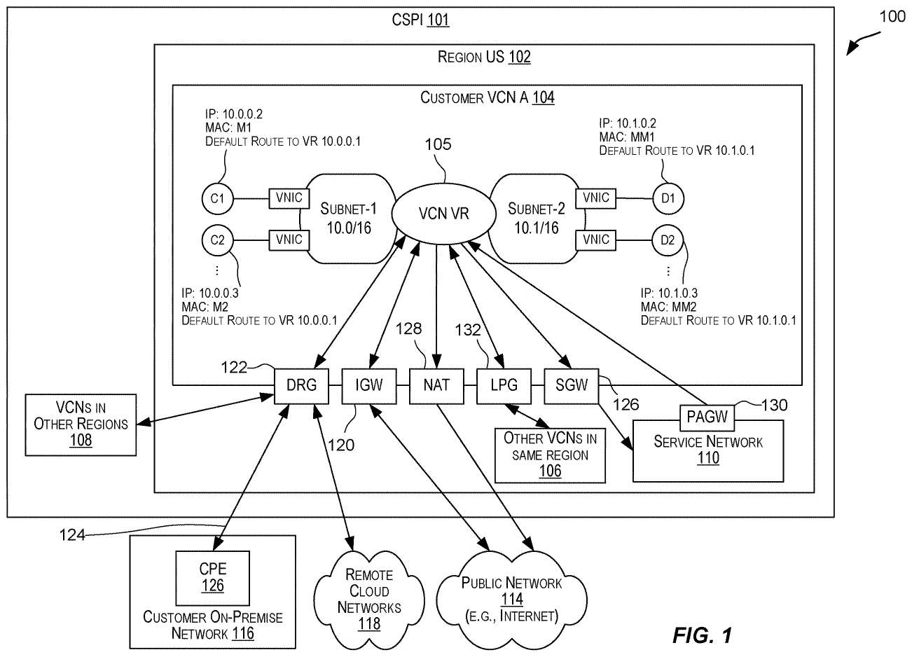

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

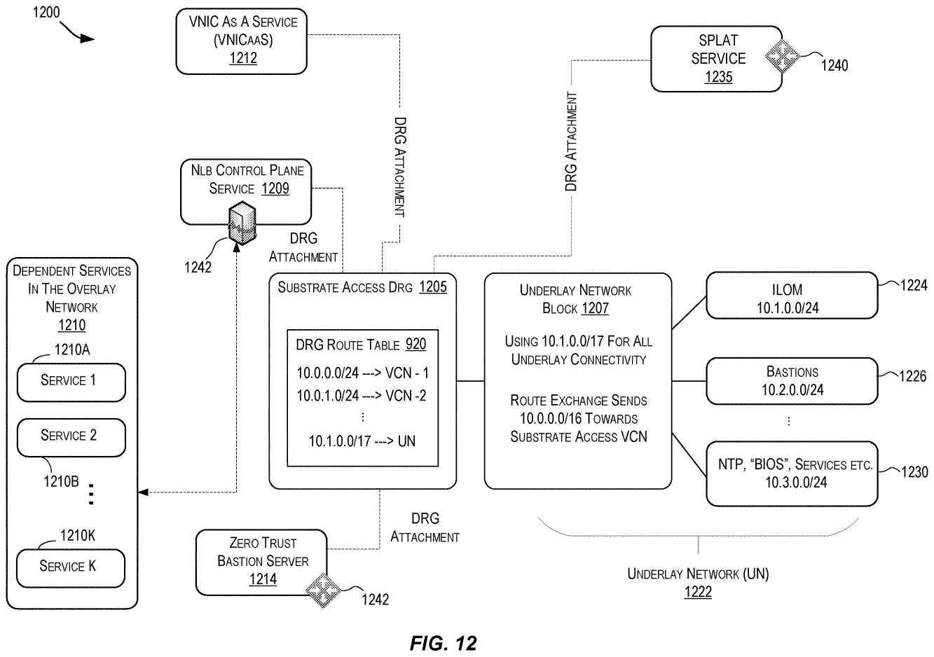

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 12, 13, 14, and 15 (see references 1216, 1316, 1416, and 1516) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 1, 2, 3, 4, 5, 12, 13, 14, and 15 are described below. FIG. 1 is a high level diagram of a distributed environment 100 showing an overlay or customer VCN hosted by CSPI according to certain embodiments. The distributed environment depicted in FIG. 1 includes multiple components in the overlay network. Distributed environment 100 depicted in FIG. 1 is merely an example and is not intended to unduly limit the scope of claimed embodiments. Many variations, alternatives, and modifications are possible. For example, in some implementations, the distributed environment depicted in FIG. 1 may have more or fewer systems or components than those shown in FIG. 1, may combine two or more systems, or may have a different configuration or arrangement of systems.

As shown in the example depicted in FIG. 1, distributed environment 100 comprises CSPI 101 that provides services and resources that customers can subscribe to and use to build their virtual cloud networks (VCNs). In certain embodiments, CSPI 101 offers IaaS services to subscribing customers. The data centers within CSPI 101 may be organized into one or more regions. One example region “Region US” 102 is shown in FIG. 1. A customer has configured a customer VCN 104 for region 102. The customer may deploy various compute instances on VCN 104, where the compute instances may include virtual machines or bare metal instances. Examples of instances include applications, database, load balancers, and the like.

In the embodiment depicted in FIG. 1, customer VCN 104 comprises two subnets, namely, “Subnet-1” and “Subnet-2”, each subnet with its own CIDR IP address range. In FIG. 1, the overlay IP address range for Subnet-1 is 10.0/16 and the address range for Subnet-2 is 10.1/16. A VCN Virtual Router 105 represents a logical gateway for the VCN that enables communications between subnets of the VCN 104, and with other endpoints outside the VCN. VCN VR 105 is configured to route traffic between VNICs in VCN 104 and gateways associated with VCN 104. VCN VR 105 provides a port for each subnet of VCN 104. For example, VR 105 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 101. A compute instance participates in a subnet via a VNIC associated with the compute instance. For example, as shown in FIG. 1, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 1, compute instance C1 has an overlay IP address of 10.0.0.2 and a MAC address of M1, while compute instance C2 has a private overlay IP address of 10.0.0.3 and a MAC address of M2. Each compute instance in Subnet-1, including compute instances C1 and C2, has a default route to VCN VR 105 using IP address 10.0.0.1, which is the IP address for a port of VCN VR 105 for Subnet-1.

Subnet-2 can have multiple compute instances deployed on it, including virtual machine instances and/or bare metal instances. For example, as shown in FIG. 1, compute instances D1 and D2 are part of Subnet-2 via VNICs associated with the respective compute instances. In the embodiment depicted in FIG. 1, compute instance D1 has an overlay IP address of 10.1.0.2 and a MAC address of MM1, while compute instance D2 has a private overlay IP address of 10.1.0.3 and a MAC address of MM2. Each compute instance in Subnet-2, including compute instances D1 and D2, has a default route to VCN VR 105 using IP address 10.1.0.1, which is the IP address for a port of VCN VR 105 for Subnet-2.

VCN A 104 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 104 can communicate with various different endpoints. These endpoints may include endpoints that are hosted by CSPI 200 and endpoints outside CSPI 200. Endpoints that are hosted by CSPI 101 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 106 or 110, communications between a compute instance in Subnet-1 and an endpoint in service network 110 in the same region); or an endpoint in a VCN in a different region (e.g., communications between a compute instance in Subnet-1 and an endpoint in a VCN in a different region 108). A compute instance in a subnet hosted by CSPI 101 may also communicate with endpoints that are not hosted by CSPI 101 (i.e., are outside CSPI 101). These outside endpoints include endpoints in the customer's on-premise network 116, endpoints within other remote cloud hosted networks 118, public endpoints 114 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 1 wants to send a packet to compute instance D1 in Subnet-2, the packet is first processed by the VNIC associated with compute instance C1. The VNIC associated with compute instance C1 is configured to route the packet to the VCN VR 105 using default route or port 10.0.0.1 of the VCN VR. VCN VR 105 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 104 to an endpoint that is outside VCN 104, the communication is facilitated by the VNIC associated with the source compute instance, VCN VR 105, and gateways associated with VCN 104. One or more types of gateways may be associated with VCN 104. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 104. The packet may be first processed by the VNIC associated with source compute instance C1. The VNIC processing determines that the destination for the packet is outside the Subnet-1 of C1. The VNIC associated with C1 may forward the packet to VCN VR 105 for VCN 104. VCN VR 105 then processes the packet and as part of the processing, based upon the destination for the packet, determines a particular gateway associated with VCN 104 as the next hop for the packet. VCN VR 105 may then forward the packet to the particular identified gateway. For example, if the destination is an endpoint within the customer's on-premise network, then the packet may be forwarded by VCN VR 105 to Dynamic Routing Gateway (DRG) gateway 122 configured for VCN 104. The packet may then be forwarded from the gateway to a next hop to facilitate communication of the packet to it final intended destination.

Various different types of gateways may be configured for a VCN. Examples of gateways that may be configured for a VCN are depicted in FIG. 1 and described below. Examples of gateways associated with a VCN are also depicted in FIGS. 12, 13, 14, and 15 (for example, gateways referenced by reference numbers 1234, 1236, 1238, 1334, 1336, 1338, 1434, 1436, 1438, 1534, 1536, and 1538) and described below. As shown in the embodiment depicted in FIG. 1, a Dynamic Routing Gateway (DRG) 122 may be added to or be associated with customer VCN 104 and provides a path for private network traffic communication between customer VCN 104 and another endpoint, where the another endpoint can be the customer's on-premise network 116, a VCN 108 in a different region of CSPI 101, or other remote cloud networks 118 not hosted by CSPI 101. Customer on-premise network 116 may be a customer network or a customer data center built using the customer's resources. Access to customer on-premise network 116 is generally very restricted. For a customer that has both a customer on-premise network 116 and one or more VCNs 104 deployed or hosted in the cloud by CSPI 101, the customer may want their on-premise network 116 and their cloud-based VCN 104 to be able to communicate with each other. This enables a customer to build an extended hybrid environment encompassing the customer's VCN 104 hosted by CSPI 101 and their on-premises network 116. DRG 122 enables this communication. To enable such communications, a communication channel 124 is set up where one endpoint of the channel is in customer on-premise network 116 and the other endpoint is in CSPI 101 and connected to customer VCN 104. Communication channel 124 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 116 that forms one end point for communication channel 124 is referred to as the customer premise equipment (CPE), such as CPE 126 depicted in FIG. 1. On the CSPI 101 side, the endpoint may be a host machine executing DRG 122.

In certain embodiments, a Remote Peering Connection (RPC) can be added to a DRG, which allows a customer to peer one VCN with another VCN in a different region. Using such an RPC, customer VCN 104 can use DRG 122 to connect with a VCN 108 in another region. DRG 122 may also be used to communicate with other remote cloud networks 118, not hosted by CSPI 101 such as a Microsoft Azure cloud, Amazon AWS cloud, and others.

As shown in FIG. 1, an Internet Gateway (IGW) 120 may be configured for customer VCN 104 the enables a compute instance on VCN 104 to communicate with public endpoints 114 accessible over a public network such as the Internet. IGW 1120 is a gateway that connects a VCN to a public network such as the Internet. IGW 120 enables a public subnet (where the resources in the public subnet have public overlay IP addresses) within a VCN, such as VCN 104, direct access to public endpoints 112 on a public network 114 such as the Internet. Using IGW 120, connections can be initiated from a subnet within VCN 104 or from the Internet.

A Network Address Translation (NAT) gateway 128 can be configured for customer's VCN 104 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 104, with private access to public endpoints on the Internet. In NAT gateways, connections can be initiated only from the private subnet to the public Internet and not from the Internet to the private subnet.

In certain embodiments, a Service Gateway (SGW) 126 can be configured for customer VCN 104 and provides a path for private network traffic between VCN 104 and supported services endpoints in a service network 110. In certain embodiments, service network 110 may be provided by the CSP and may provide various services. An example of such a service network is Oracle's Services Network, which provides various services that can be used by customers. For example, a compute instance (e.g., a database system) in a private subnet of customer VCN 104 can back up data to a service endpoint (e.g., Object Storage) without needing public IP addresses or access to the Internet. In certain embodiments, a VCN can have only one SGW, and connections can only be initiated from a subnet within the VCN and not from service network 110. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 126 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 132 is a gateway that can be added to customer VCN 104 and enables VCN 104 to peer with another VCN in the same region. Peering means that the VCNs communicate using private IP addresses, without the traffic traversing a public network such as the Internet or without routing the traffic through the customer's on-premises network 116. In preferred embodiments, a VCN has a separate LPG for each peering it establishes. Local Peering or VCN Peering is a common practice used to establish network connectivity between different applications or infrastructure management functions.

Service providers, such as providers of services in service network 110, may provide access to services using different access models. According to a public access model, services may be exposed as public endpoints that are publicly accessible by compute instance in a customer VCN via a public network such as the Internet and or may be privately accessible via SGW 126. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 130 is a gateway resource that can be attached to a service provider VCN (e.g., a VCN in service network 110) that acts as an ingress/egress point for all traffic from/to customer subnet private endpoints. PAGW 130 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 130 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 132 and the PE in the customer's VCN.

A customer can control routing in a VCN at the subnet level, so the customer can specify which subnets in the customer's VCN, such as VCN 104, use each gateway. A VCN's route tables are used to decide if traffic is allowed out of a VCN through a particular gateway. For example, in a particular instance, a route table for a public subnet within customer VCN 104 may send non-local traffic through IGW 120. The route table for a private subnet within the same customer VCN 104 may send traffic destined for CSP services through SGW 126. All remaining traffic may be sent via the NAT gateway 128. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 104) can be categorized as public access, private access, or dedicated access. Public access refers to an access model where a public IP address or a NAT is used to access a public endpoint. Private access enables customer workloads in VCN 104 with private IP addresses (e.g., resources in a private subnet) to access services without traversing a public network such as the Internet. In certain embodiments, CSPI 101 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

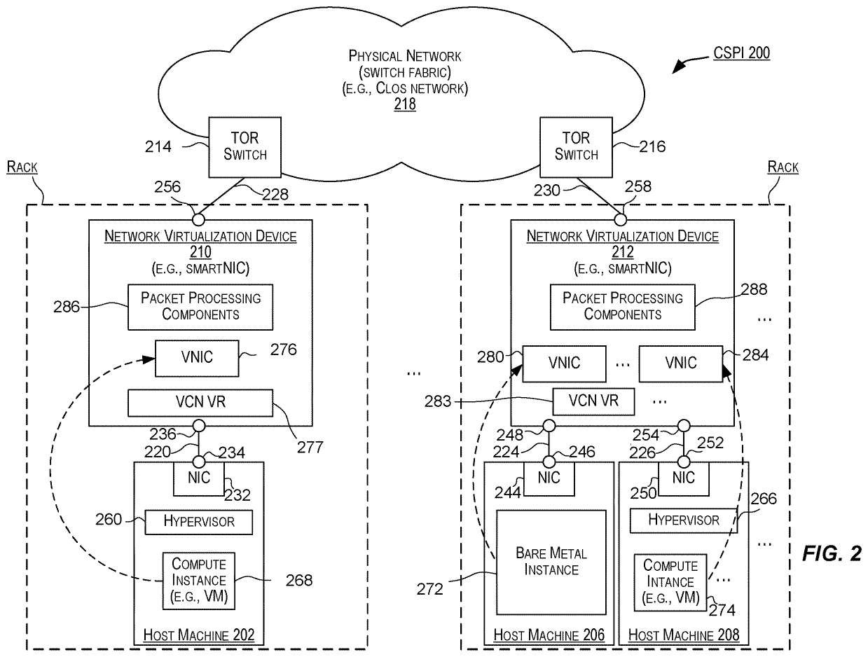

FIG. 1 and the accompanying description above describes various virtualized components in an example virtual network. As described above, the virtual network is built on the underlying physical or substrate network. FIG. 2 depicts a simplified architectural diagram of the physical components in the physical network within CSPI 200 that provide the underlay for the virtual network according to certain embodiments. As shown, CSPI 200 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 200 are provisioned for the customer. Customers can then build their own cloud-based (i.e., CSPI-hosted) customizable and private virtual networks using physical compute, memory, and networking resources provided by CSPI 200. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 200 provides infrastructure and a set of complementary cloud services that enable customers to build and run a wide range of applications and services in a highly available hosted environment.

In the example embodiment depicted in FIG. 2, the physical components of CSPI 200 include one or more physical host machines or physical servers (e.g., 202, 206, 208), network virtualization devices (NVDs) (e.g., 210, 212), top-of-rack (TOR) switches (e.g., 214, 216), and a physical network (e.g., 218), and switches in physical network 218. The physical host machines or servers may host and execute various compute instances that participate in one or more subnets of a VCN. The compute instances may include virtual machine instances, and bare metal instances. For example, the various compute instances depicted in FIG. 1 may be hosted by the physical host machines depicted in FIG. 2. The virtual machine compute instances in a VCN may be executed by one host machine or by multiple different host machines. The physical host machines may also host virtual host machines, container-based hosts or functions, and the like. The VNICs and VCN VR depicted in FIG. 1 may be executed by the NVDs depicted in FIG. 2. The gateways depicted in FIG. 1 may be executed by the host machines and/or by the NVDs depicted in FIG. 2.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 2, host machines 202 and 208 execute hypervisors 260 and 266, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 2, hypervisor 260 may sit on top of the OS of host machine 202 and enables the computing resources (e.g., processing, memory, and networking resources) of host machine 202 to be shared between compute instances (e.g., virtual machines) executed by host machine 202. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 2 may have the same or different types of hypervisors.

A compute instance can be a virtual machine instance or a bare metal instance. In FIG. 2, compute instances 268 on host machine 202 and 274 on host machine 208 are examples of virtual machine instances. Host machine 206 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 2, host machine 202 executes a virtual machine compute instance 268 that is associated with VNIC 276, and VNIC 276 is executed by NVD 210 connected to host machine 202. As another example, bare metal instance 272 hosted by host machine 206 is associated with VNIC 280 that is executed by NVD 212 connected to host machine 206. As yet another example, VNIC 284 is associated with compute instance 274 executed by host machine 208, and VNIC 284 is executed by NVD 212 connected to host machine 208.

For compute instances hosted by a host machine, an NVD connected to that host machine also executes VCN VRs corresponding to VCNs of which the compute instances are members. For example, in the embodiment depicted in FIG. 2, NVD 210 executes VCN VR 277 corresponding to the VCN of which compute instance 268 is a member. NVD 212 may also execute one or more VCN VRs 283 corresponding to VCNs corresponding to the compute instances hosted by host machines 206 and 208.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 2, host machine 202 is connected to NVD 210 using link 220 that extends between a port 234 provided by a NIC 232 of host machine 202 and between a port 236 of NVD 210. Host machine 206 is connected to NVD 212 using link 224 that extends between a port 246 provided by a NIC 244 of host machine 206 and between a port 248 of NVD 212. Host machine 208 is connected to NVD 212 using link 226 that extends between a port 252 provided by a NIC 250 of host machine 208 and between a port 254 of NVD 212.

The NVDs are in turn connected via communication links to top-of-the-rack (TOR) switches, which are connected to physical network 218 (also referred to as the switch fabric). In certain embodiments, the links between a host machine and an NVD, and between an NVD and a TOR switch are Ethernet links. For example, in FIG. 2, NVDs 210 and 212 are connected to TOR switches 214 and 216, respectively, using links 228 and 230. In certain embodiments, the links 220, 224, 226, 228, and 230 are Ethernet links. The collection of host machines and NVDs that are connected to a TOR is sometimes referred to as a rack.

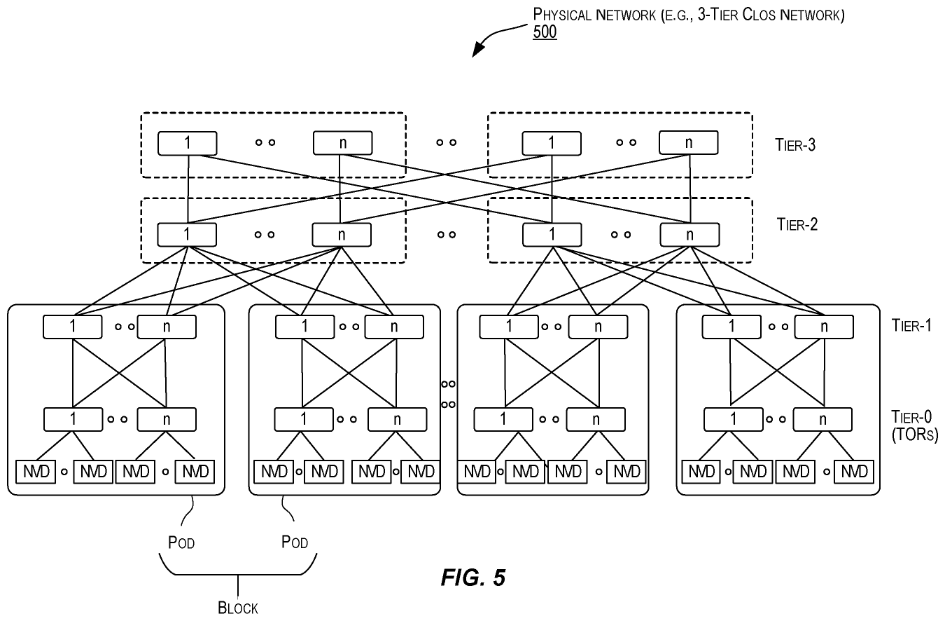

Physical network 218 provides a communication fabric that enables TOR switches to communicate with each other. Physical network 218 can be a multi-tiered network. In certain implementations, physical network 218 is a multi-tiered Clos network of switches, with TOR switches 214 and 216 representing the leaf level nodes of the multi-tiered and multi-node physical switching network 218. Different Clos network configurations are possible including but not limited to a 2-tier network, a 3-tier network, a 4-tier network, a 5-tier network, and in general a “n”-tiered network. An example of a Clos network is depicted in FIG. 5 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 2, host machine 202 is connected to NVD 210 via NIC 232 of host machine 202. In a many-to-one configuration, multiple host machines are connected to one NVD. For example, in FIG. 2, host machines 206 and 208 are connected to the same NVD 212 via NICs 244 and 250, respectively.

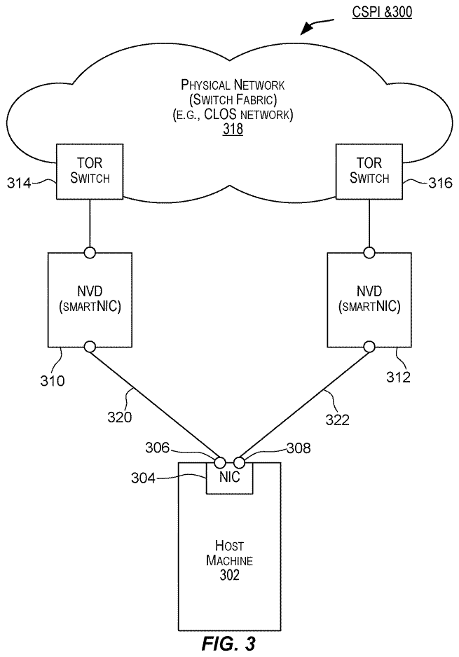

In a one-to-many configuration, one host machine is connected to multiple NVDs. FIG. 3 shows an example within CSPI 300 where a host machine is connected to multiple NVDs. As shown in FIG. 3, host machine 302 comprises a network interface card (NIC) 304 that includes multiple ports 306 and 308. Host machine 300 is connected to a first NVD 310 via port 306 and link 320, and connected to a second NVD 312 via port 308 and link 322. Ports 306 and 308 may be Ethernet ports and the links 320 and 322 between host machine 302 and NVDs 310 and 312 may be Ethernet links. NVD 310 is in turn connected to a first TOR switch 314 and NVD 312 is connected to a second TOR switch 316. The links between NVDs 310 and 312, and TOR switches 314 and 316 may be Ethernet links. TOR switches 314 and 316 represent the Tier-0 switching devices in multi-tiered physical network 318.

The arrangement depicted in FIG. 3 provides two separate physical network paths to and from physical switch network 318 to host machine 302: a first path traversing TOR switch 314 to NVD 310 to host machine 302, and a second path traversing TOR switch 316 to NVD 312 to host machine 302. The separate paths provide for enhanced availability (referred to as high availability) of host machine 302. If there are problems in one of the paths (e.g., a link in one of the paths goes down) or devices (e.g., a particular NVD is not functioning), then the other path may be used for communications to/from host machine 302.

In the configuration depicted in FIG. 3, the host machine is connected to two different NVDs using two different ports provided by a NIC of the host machine. In other embodiments, a host machine may include multiple NICs that enable connectivity of the host machine to multiple NVDs.

Referring back to FIG. 2, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 2, the NVDs 210 and 212 may be implemented as smartNICs that are connected to host machines 202, and host machines 206 and 208, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 200. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 2, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 2 include port 236 on NVD 210, and ports 248 and 254 on NVD 212. A network-facing port of an NVD is a port that is used to connect the NVD to a TOR switch. Examples of network-facing ports in FIG. 2 include port 256 on NVD 210, and port 258 on NVD 212. As shown in FIG. 2, NVD 210 is connected to TOR switch 214 using link 228 that extends from port 256 of NVD 210 to the TOR switch 214. Likewise, NVD 212 is connected to TOR switch 216 using link 230 that extends from port 258 of NVD 212 to the TOR switch 216.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with cis in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 12, 13, 14, and 15 (see references 1216, 1316, 1416, and 1516) and described below. Examples of a VCN Data Plane are depicted in FIGS. 12, 13, 14, and 15 (see references 1218, 1318, 1418, and 1518) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 2, NVD 210 executes the functionality for VNIC 276 that is associated with compute instance 268 hosted by host machine 202 connected to NVD 210. As another example, NVD 212 executes VNIC 280 that is associated with bare metal compute instance 272 hosted by host machine 206, and executes VNIC 284 that is associated with compute instance 274 hosted by host machine 208. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 2, NVD 210 executes VCN VR 277 corresponding to the VCN to which compute instance 268 belongs. NVD 212 executes one or more VCN VRs 283 corresponding to one or more VCNs to which compute instances hosted by host machines 206 and 208 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 2. For example, NVD 210 comprises packet processing components 286 and NVD 212 comprises packet processing components 288. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 1 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 1 may be executed or hosted by one or more of the physical components depicted in FIG. 2. For example, the compute instances in a VCN may be executed or hosted by one or more host machines depicted in FIG. 2. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 2, a packet originating from compute instance 268 may be communicated from host machine 202 to NVD 210 over link 220 (using NIC 232). On NVD 210, VNIC 276 is invoked since it is the VNIC associated with source compute instance 268. VNIC 276 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 200 and endpoints outside CSPI 200. Endpoints hosted by CSPI 200 may include instances in the same VCN or other VCNs, which may be the customer's VCNs, or VCNs not belonging to the customer. Communications between endpoints hosted by CSPI 200 may be performed over physical network 218. A compute instance may also communicate with endpoints that are not hosted by CSPI 200, or are outside CSPI 200. Examples of these endpoints include endpoints within a customer's on-premise network or data center, or public endpoints accessible over a public network such as the Internet. Communications with endpoints outside CSPI 200 may be performed over public networks (e.g., the Internet) (not shown in FIG. 2) or private networks (not shown in FIG. 2) using various communication protocols.

The architecture of CSPI 200 depicted in FIG. 2 is merely an example and is not intended to be limiting. Variations, alternatives, and modifications are possible in alternative embodiments. For example, in some implementations, CSPI 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

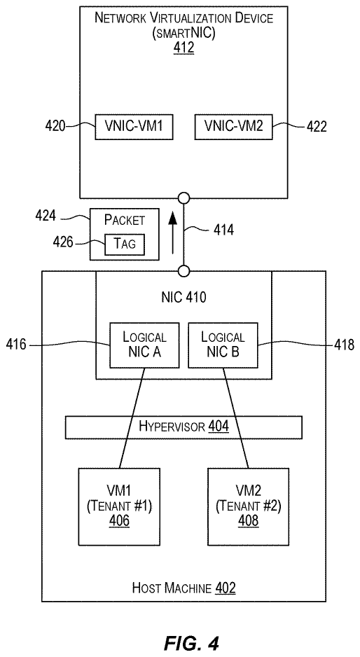

FIG. 4 depicts connectivity between a host machine and an NVD for providing I/O virtualization for supporting multitenancy according to certain embodiments. As depicted in FIG. 4, host machine 402 executes a hypervisor 404 that provides a virtualized environment. Host machine 402 executes two virtual machine instances, VM1 406 belonging to customer/tenant #1 and VM2 408 belonging to customer/tenant #2.Host machine 402 comprises a physical NIC 410 that is connected to an NVD 412 via link 414. Each of the compute instances is attached to a VNIC that is executed by NVD 412. In the embodiment in FIG. 4, VM1 406 is attached to VNIC-VM1 420 and VM2 408 is attached to VNIC-VM2 422.

As shown in FIG. 4, NIC 410 comprises two logical NICs, logical NIC A 416 and logical NIC B 418. Each virtual machine is attached to and configured to work with its own logical NIC. For example, VM1 406 is attached to logical NIC A 416 and VM2 408 is attached to logical NIC B 418. Even though host machine 402 comprises only one physical NIC 410 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 416 for Tenant #1 and a separate VLAN ID is assigned to logical NIC B 418 for Tenant #2. When a packet is communicated from VM1 406, a tag assigned to Tenant #1 is attached to the packet by the hypervisor and the packet is then communicated from host machine 402 to NVD 412 over link 414. In a similar manner, when a packet is communicated from VM2 408, a tag assigned to Tenant #2 is attached to the packet by the hypervisor and the packet is then communicated from host machine 402 to NVD 412 over link 414. Accordingly, a packet 424 communicated from host machine 402 to NVD 412 has an associated tag 426 that identifies a specific tenant and associated VM. On the NVD, for a packet 424 received from host machine 402, the tag 426 associated with the packet is used to determine whether the packet is to be processed by VNIC-VM1 420 or by VNIC-VM2 422. The packet is then processed by the corresponding VNIC. The configuration depicted in FIG. 4 enables each tenant's compute instance to believe that they own their own host machine and NIC. The setup depicted in FIG. 4 provides for I/O virtualization for supporting multi-tenancy.

FIG. 5 depicts a simplified block diagram of a physical network 500 according to certain embodiments. The embodiment depicted in FIG. 5 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 5 is a 3-tiered network comprising tiers 1, 2, and 3. The TOR switches 504 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 5, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 500 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-O-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>.[REGION][.FUTURE USE].<UNIQUE ID>
where,
ocid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

### Dedicated Cloud Region

A dedicated cloud region means a fully managed cloud service provider (CSP) region that is deployed within a customer's own data center, thereby allowing the customers to access all the features of a public cloud offering while maintaining complete control over their data and meeting strict data residency requirements. In other words, the dedicated cloud region is a private cloud built on the CSP's infrastructure within the customer's facility.

The adoption of cloud services has seen a rapid uptick in recent times. Various types of cloud services are now provided by various different cloud service providers (CSPs). The term cloud service is generally used to refer to a service or functionality that is made available by a CSP to users or customers on demand (e.g., via a subscription model) using systems and infrastructure (cloud infrastructure) provided by the CSP. Typically, the servers and systems that make up the CSP's infrastructure and which is used to provide a cloud service to a customer are separate from the customer's own on-premises servers and systems. Customers can thus avail themselves of cloud services provided by the CSP without having to purchase separate hardware and software resources for the services. Cloud services are designed to provide a subscribing customer easy, scalable, and on-demand access to applications and computing resources without the customer having to invest in procuring the infrastructure that is used for providing the services or functions. Various different types or models of cloud services may be offered such as Software-as-a-Service (SaaS), Platform-as-a-Service (PaaS), Infrastructure-as-a-Service (IaaS), and others. A customer can subscribe to one or more cloud services provided by a CSP. The customer can be any entity such as an individual, an organization, an enterprise, and the like.

As indicated above, a CSP is responsible for providing the infrastructure and resources that are used for providing cloud services to subscribing customers. The resources provided by the CSP can include both hardware and software resources. These resources can include, for example, compute resources (e.g., virtual machines, containers, applications, processors), memory resources (e.g., databases, data stores), networking resources (e.g., routers, host machines, load balancers), identity, and other resources. In certain implementations, the resources provided by a CSP for providing a set of cloud services CSP are organized into data centers. The process of providing such resources into the data centers is referred to a Region Build. A data center may be configured to provide a particular set of cloud services. The CSP is responsible for equipping the data center with infrastructure and resources that are used to provide that particular set of cloud services. A CSP may build one or more data centers.

The following definitions are useful for portions of a data center built by a CSP:

Region Build refers to the process of setting up and deploying a cloud computing infrastructure within a specific geographical region, essentially establishing a data center network in a particular location to provide cloud services to users situated nearby, allowing for faster access and improved performance based on their geographical proximity.

Underlay Network—The physical network that sits below an overlay network and virtual cloud networks (VCNs) therein. The existing substrate network is a portion of the underlay Network. ILOM ports, management and Bastion servers are also part of the underlay network.

Overlay Network—An overlay network is a virtual network that is built on top of an existing physical network infrastructure. It allows for the creation of custom networking structures that operate independently from the underlying physical layer. This can provide additional features like better security, privacy, routing flexibility, or scalability. In an overlay network, virtual connections (often called tunnels) are established between nodes (such as computers, devices, or servers) over the physical network. The overlay network uses the underlying network as a medium to carry traffic, but the data is usually encapsulated in a way that it appears as if it's being transmitted over its own separate network. Overlay network corresponds to a network environment that is available for use by executing services and applications, including virtualization environments, which provide the functionality of the data center to both customers and the CSP. The overlay network can include VCN(s), virtualization environments, and networking connections from these VCNs in the reduced footprint data center to other cloud computing services of the CSP (e.g., services provided in other data center environments).

Substrate Network—A portion of the Underlay Network that contains host devices (e.g., bare metal computing devices and/or VMs) running only Substrate Services. In existing environments these host devices may not have SmartNICs. The host devices may be managed by service teams responsible for one or more of the Substrate Services.

Substrate Services—The list of services that currently run in the Substrate Network, while most of these run in service enclave (Block Storage, Object Storage, Identity Service etc.) some substrate service live outside of the service enclave. Currently substrate services have a mix of services that must talk to the underlay network (e.g., Network Monitoring) and services that due to historical reasons reside in service enclave (e.g., Object Storage). With the elimination of dedicated substrate host, it is expected that the substrate services will converge into only services that must communicate with the underlay network.

A SmartNIC (Smart Network Interface Card), also referred to herein as a Network Virtualization Device (NVD) is an advanced type of network interface card that includes processing power and other intelligent features, allowing it to offload certain networking tasks from the main CPU. This offloading capability improves performance, reduces latency, and enhances the overall efficiency of data processing in high-performance environments, like data centers, cloud computing, and high-frequency trading. Unlike traditional NICs, which mainly provide basic network connectivity, SmartNICs are designed with additional capabilities to handle more complex networking functions directly on the NIC hardware.

BIOS Device(s)—A computing device or a plurality of computing devices on a server rack in the reduced footprint data center. The BIOS Device(s) may be designed to enable independent and resilient operations during various boot scenarios and network disruptions. The BIOS Device(s) may be configured to facilitate the initial boot processes for the reduced footprint data center, provide essential services during recovery, and ensure the region's stability, especially in power-constrained environments. The BIOS Device hosts a range of functions, all of which can allow the autonomous operation of the region. For example, these functions can include DNS resolution, NTP synchronization, DHCP/ZTP configuration, and various security and provisioning services. By offering these capabilities, the BIOS Device ensures that the rack can bootstrap itself, recover from power or network-related events, and maintain essential connectivity and management functions without relying on external resources. For example, each server rack can have one BIOS device or can have two or three BIOS devices. In various embodiments, the BIOS device can have similar hardware specifications (e.g., number of processors, amount of memory, amount of attached storage devices) as other server devices on the rack.

A Bastion (or bastion host) is a server or system that is specifically designed and configured to be a secure entry point into a private or protected network. It acts as a gateway between an external, untrusted network (such as the internet) and a more secure internal network. Bastions are commonly used to control and limit access to sensitive resources in private environments, such as cloud networks, private data centers, or corporate networks.

A Network Timing Server executes a network timing server protocol (NTP) that is used to synchronize the clocks of computers and other devices over a network to ensure they have the correct time. NTP is critical in many systems and applications, such as logging events, coordinating transactions, and ensuring time-based security measures (like certificates or encryption keys).

CIDR stands for Classless Inter-Domain Routing, and it's a method used for IP address allocation and routing in networks.

A Geneve tunnel (Generic Network Virtualization Encapsulation) is a network tunneling protocol designed to encapsulate various types of network traffic over a virtualized network, such as a Software-Defined Network (SDN) or a network virtualization environment. It is used to create network overlays, enabling the efficient transport of data packets across different physical networks. Geneve is an encapsulation protocol, meaning it wraps (encapsulates) data packets from one protocol (e.g., Ethernet frames) into Geneve packets for transmission across a network, allowing the original traffic to be isolated and carried over a different underlying network infrastructure.

A reduced footprint data center can have a new architecture for a region in which the initial network footprint is as small as feasible (e.g., six racks, four racks, and possibly even a single rack of server devices) while still providing core cloud services and scalability for customer demands. In particular, a reduced footprint data center may not segregate resources for the Service Enclave (SE) from the Customer Enclave (CE). A dedicated cloud region in such an infrastructure is referred to herein as a ‘Butterfly Region’. The Butterfly region will place SE services (e.g., Certificates, Block Storage, Object Storage, Identity, Key Management, Secrets), which primarily operate in a substrate network, into an overlay network. This means that a Butterfly region will not have dedicated hosts for the substrate network but will require particular solutions for connectivity with the Substrate services now in the overlay network. In addition, a small portion of fundamental boot services is needed to ensure initial route configuration for the services in the Overlay during startup and/or recovery.

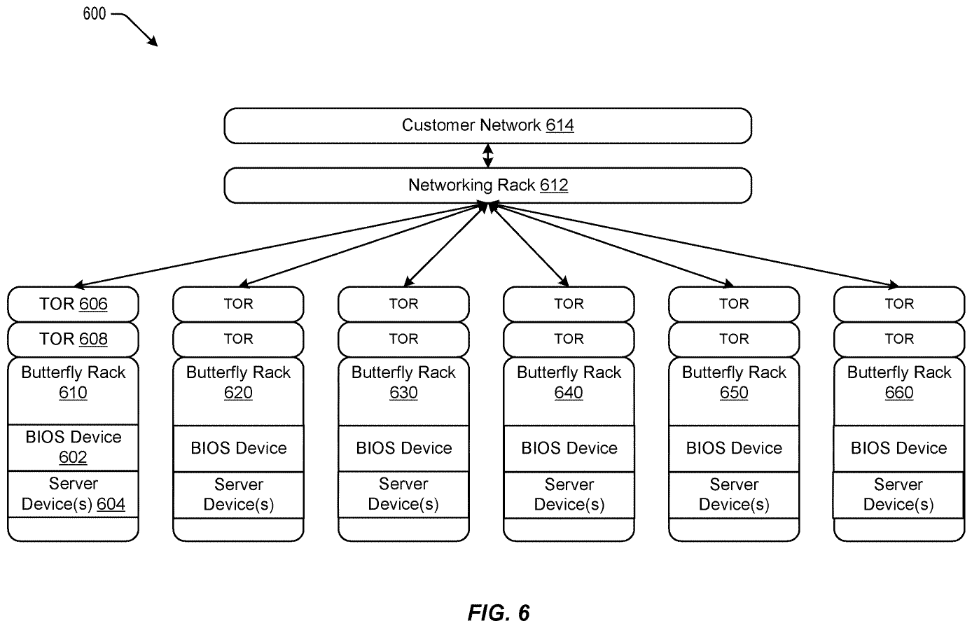

Unifying the architecture such that SE services operate in the same overlay network as customer services affords the Butterfly region with great flexibility, particularly when scaling out to meet the needs of customers of the Butterfly region. In particular, the initial, small network footprint can be augmented with additional server racks that provide additional computing and storage resources for use by the customer. FIGS. 6-9 provide an overview of the concepts embodied by a reduced footprint data center.

FIG. 6 is a block diagram illustrating an example system architecture of a reduced footprint data center (RFDC) 100 including an initialization device 602. As shown in FIG. 6, the reduced footprint data center 100 can include six racks of server devices. The racks may be referred to as “Butterfly” racks. The reduced footprint data center 100 can include Butterfly rack 610, Butterfly rack 620, Butterfly rack 630, Butterfly rack 640, Butterfly rack 650, and Butterfly rack 660. In some embodiments, the racks can be identical. For example, Butterfly rack 610 can include the same number of computing and/or networking devices as each other Butterfly rack 620-660.

Butterfly rack 610 can include two top-of-rack (TOR) switches 606, 608. The TOR switches 606, 608 can each include one or more networking switches configured to provide network communication between the server devices and other computing devices within Butterfly rack 610 as well as one or more networking connections to the other Butterfly racks 620-660 and or other networks including customer network 614.

The Butterfly rack 610 can also include one or more BIOS device(s) 602. The BIOS device can be a server device configured to execute one or more processes to provide a set of “core services” within the reduced footprint data center 100 during startup/boot processes. The BIOS device(s) 602 can configure one or more components of the reduced footprint data center 100 during startup. For example, the BIOS device(s) 602 can send network configuration information to a networking device within the Butterfly racks 610-660. The networking device can be a SmartNIC attached to a server device within the Butterfly racks 610-660. As another example, the BIOS device(s) 602 can send network configuration information to a substrate access VCN. The substrate access VCN can be deployed to one or more hosts within the reduced footprint data center 100. For example, VMs executing in the Butterfly racks 610-660 can be configured to be a substrate access VCN. The substrate access VCN can be configured to provide networking routes between one or more other VCNs (e.g., customer VCNs) and the networking devices (e.g., SmartNICs) and other networking components of the substrate services that now execute in their own VCN in the Overlay.

In some embodiments, the BIOS device(s) 602 can also be configured to host one or more services like a key exchange service (KeS), a device encryption key (DEK) service, or other core services. In addition, the BIOS device(s) 602 can include boot volumes for VMs that are started on host devices in the reduced footprint data center 100. For example, BIOS device(s) 602 can provide boot volumes for VMs on hypervisors hosted on server device(s) 604.

The Butterfly rack 610 can include one or more additional server device(s) 604. The server device(s) 604 can each include one or more processors and one or more memories that together can store and execute instructions for implementing computing services as described herein, including, for example, compute, storage, VMs, CSP services, customer services and/or applications, and the like. As depicted in FIG. 6, each of the Butterfly racks 610-660 can include an identical complement of server device(s) and TORs. In some embodiments, each of the Butterfly racks 610-660 can include a BIOS device, although the techniques described herein can be implemented using only a single BIOS device within the reduced footprint data center 100. Each server device of the server device(s) 604 can include a trusted platform module (TPM). The TPM on each device can be a microcontroller or other processor (or multiple processors) along with storage for performing cryptographical operations like hashing, encryption/decryption, key and key pair generation, and key storage. The TPM may generally conform to a standard characterizing such devices, for example, ISO/IEC 11889.

The reduced footprint data center 100 can also include a networking rack 612. The networking rack 612 can include one or more networking devices including switches, gateways, routers, and the like for communicatively coupling the Butterfly racks 610-660 to each other and to customer network 614. The customer network 614 can include an on-premises network connected to the reduced footprint data center 100. In some embodiments, the customer network 614 can provide network connectivity to a public network, including the Internet. As described below with respect to FIG. 2, the networking rack 612 may not be part of an initial “Small” reduced footprint data center and may be added to support the scaling of the reduced footprint data center 100.

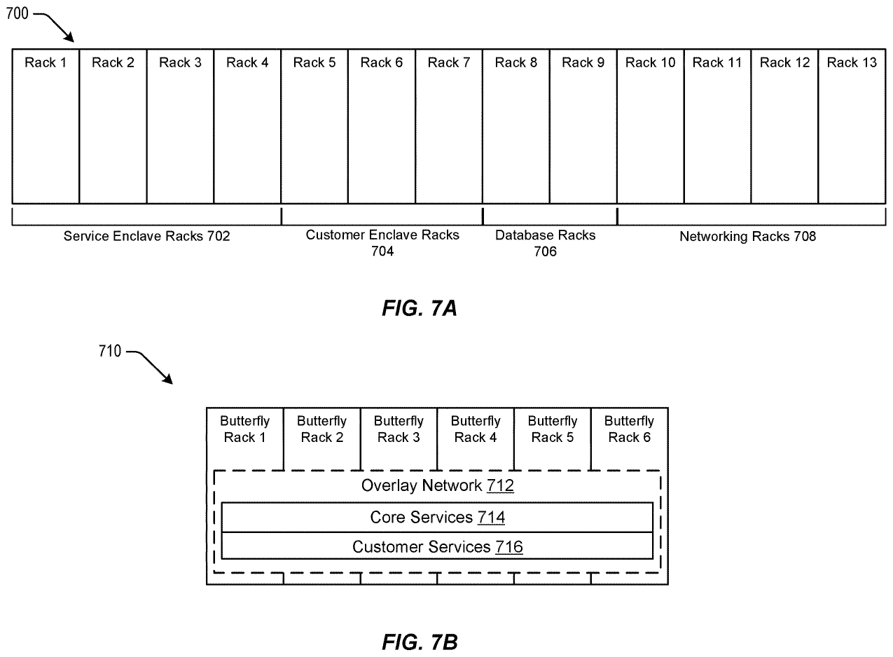

FIG. 7A is a block diagram illustrating a conventional data center 700 including a plurality of server racks reserved for particular functionality. In a conventional data center 700, the plurality of server racks can each include multiple server devices as well as networking equipment (e.g., TORs) and power supply and distribution equipment. The conventional data center 700 shown in FIG. 7A can have a standard footprint of 13 server racks as shown, although additional server racks are possible in larger data centers.

To provide networking isolation between customer data and CSP data for CSP services executing in the conventional data center 700, a portion of the server racks can be reserved as a service enclave, so that the computing devices on those server racks can host and provide CSP services within the conventional data center 700 without also hosting customer data. As shown in FIG. 7A, server racks 1-4 may be included as service enclave racks 702.

Similarly, a portion of the server racks can be provided as a customer enclave, so that the computing devices on those server racks can host customer services, applications, and associated customer data. Racks 5-7 can be part of the customer enclave racks 704 within conventional data center 700.

The isolation between the service enclave and the customer enclave can be enforced by software-defined perimeters that define edge devices and/or software within the enclave as distinguished from hardware/software elements outside of the enclave. Access into and out of each enclave may be controlled, monitored, and/or policy driven. For example, access to the service enclave may be based on authorization, limited to authorized clients of the CSP. Such access may be based on one or more credentials provided to the enclave.

The conventional data center 700 can also include database racks 706 (racks 8-9) and networking racks 708 (racks 10-13). The database racks 706 can include computing devices and storage devices that provide storage and management for databases, data stores, object storage, and similar data persistence techniques within the conventional data center 700. The networking racks 708 can include networking devices that provide connectivity to the computing devices within conventional data center 700 and to other networks (e.g., customer networks, the internet, etc.).

FIG. 7B is a block diagram illustrating a reduced footprint data center 710 in which services are in an overlay network, according to some embodiments. The reduced footprint data center 710 may be an example of reduced footprint data center 100 of FIG. 1, including six Butterfly racks, each having a plurality of server devices, networking devices, and power distribution devices.

Unlike the conventional data center 700, in which particular server racks are reserved as service enclave racks 702 and customer enclave racks 704, the reduced footprint data center 710 can have an Overlay network 712 that spans computing devices in all of the server racks. For example, server devices on Butterfly Rack 1 and Butterfly Rack 6 can host VMs for a VCN in the Overlay network 712. The Overlay network 712 can then include both core services 714 and customer services 716. The core services 714 can include one or more VCNs for the CSP services that would be hosted within the Service Enclave of conventional data center 700 (e.g., on service enclave racks 702). In the reduced footprint data center 710, the core services 714 can exist in the overlay network 712 on any one or more of the server devices within Butterfly racks. Similarly, customer services 716 can exist in the overlay network 712 on host devices on any of the Butterfly racks. In some embodiments the core services 714 may be hosted on specific devices of the reduced footprint data center. For example, the core services 714 may be hosted on Butterfly racks 1-3, while the customer services 716 may be hosted on Butterfly racks 4-6. In other embodiments, the core services 714 and the customer services 716 may be hosted on any of the Butterfly racks, as depicted in FIG. 7B.

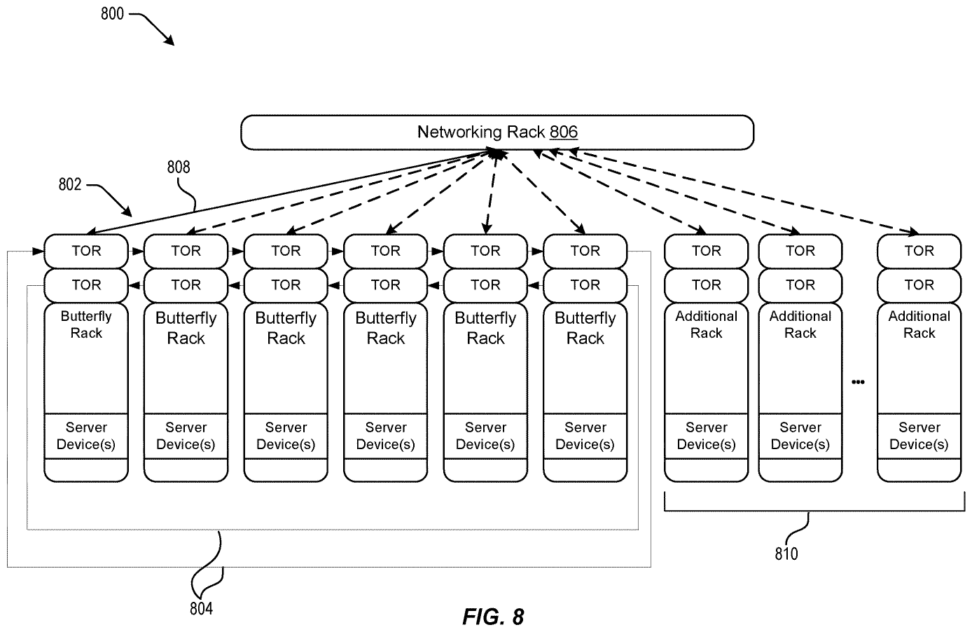

FIG. 8 is a block diagram illustrating the expansion of a reduced footprint data center 800, according to some embodiments. The reduced footprint data center 800 can include a plurality of reduced footprint server racks 802. Each of the plurality of reduced footprint server racks 802 can be an example of one of the Butterfly racks 110-160 described above with respect to FIG. 6.

The plurality of reduced footprint server racks 802 can be connected in a ring network 804 using directional network connection between each seat of TOR switches on each of the server racks. For example, a first TOR switch at each rack can be connected to a first TOR switch of two adjacent server racks, such that data communication from the server rack flows in one direction. A second TOR switch at each rack can be connected to a second TOR switch of two adjacent server racks, providing data communication between the racks in the opposite direction. The first TOR switch and the second TOR switch at each rack can be connected to one another and to each server device on the rack, providing multiple, redundant network paths from any server device of any one server rack to another server device on another server rack. The ring network 804 can therefore allow low latency and highly available network connections between resources hosted on any computing device (e.g., server device) in the plurality of reduced footprint server racks 802.

To scale the reduced footprint data center 800 from the initial footprint provided by reduced footprint server racks 802, additional server racks can be connected to the reduced footprint server racks 802. A networking rack 806 can be implemented at the reduced footprint data center 800. The networking rack 806 can be an example of networking rack 110 described above with respect to FIG. 1. The networking rack 806 can include a plurality of networking ports that can be used to connect to one or more of the plurality of reduced footprint server racks. For example, the networking rack 806 can be connected to a first reduced footprint server rack using connection 808. The networking rack 806 can be, for example, a two chassis system having 4 LCs each with 34×400G ports for a total of 384×100G links in each chassis.

Once the networking rack 806 has been implemented and connected, the additional server racks 810 can be installed in the reduced footprint data center 800. The additional server racks 810 can be different from the reduced footprint server racks of the plurality of reduced footprint server racks 802. For example, the additional server racks 810 can include a different number of server devices, with each server device including a different amount of computing and/or storage resources (e.g., processors, processing cores, dynamic memory, non-volatile storage, etc.). Once the additional server racks 810 have been connected to the networking rack 806, a cloud service hosted on the plurality of reduced footprint server racks 802 can be expanded to utilize the computing resources of the additional server racks 810. As one example, a cloud service (e.g., compute) hosted in the plurality of reduced footprint server racks 802 can have a portion of its data plane provisioned on one of the server devices of the additional server racks 810, thereby allowing the compute service to instantiate VMs on the additional server racks 810.

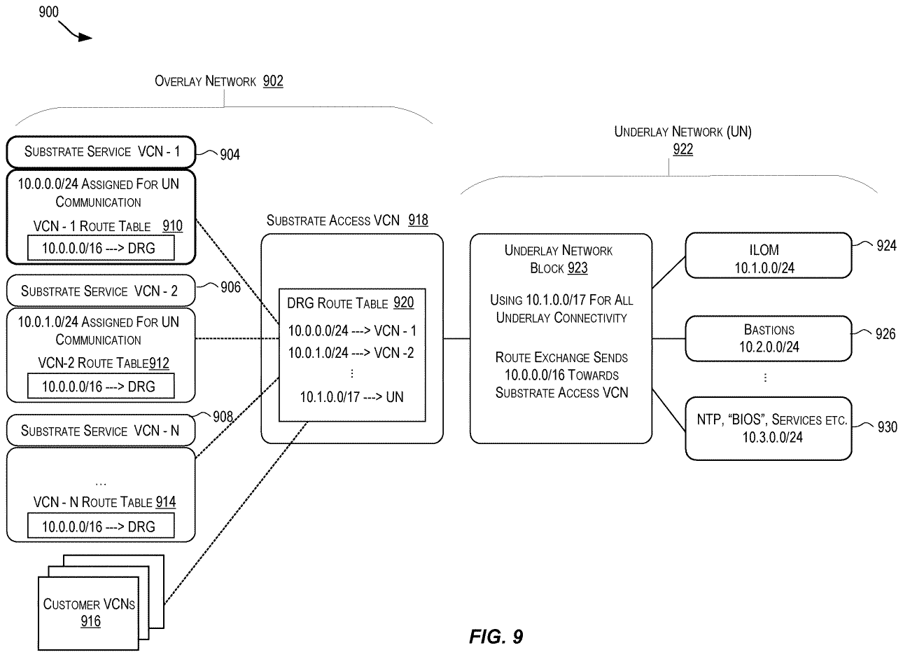

Turning to FIG. 9, there is illustrated an exemplary customer model of a reduced footprint data center 900, according to some embodiments. Specifically, FIG. 9 illustrates an example network architecture of establishing connections between one or more VCNs in an overlay network 902 and endpoints included in an underlay network 922, according to some embodiments. It is noted that the reduced footprint data center 900 can be an example of a reduced footprint data center as described herein with reference to FIG. 7B.

It is noted that in the reduced footprint data center 900, the CSP services that are traditionally implemented in a service enclave (SE) e.g., hosted on service enclave racks 702 of FIG. 7A, are now executed in one or more substrate service VCNs. For example, as shown in FIG. 9, the overlay network 902 includes a plurality of substrate service VCNs (e.g., substrate service VCN-1 to substrate service VCN-N, 904-908). Further, substrate service VCN-1 904 may be a VCN for a compute service(s), whereas substrate service VCN-2 906 can be a VCN for a PKI services, and substrate service VCN-N 908 may be a VCN for a Block Storage service. It is appreciated that the above list of types of services provided by the different service VCNs is for explanatory purposes only and is not intended to limit the scope of the present disclosure. Additionally, as shown in FIG. 9, the overlay network 902 can also include one or more customer VCNs 916, which may be limited in their connectivity to the underlay network 922.

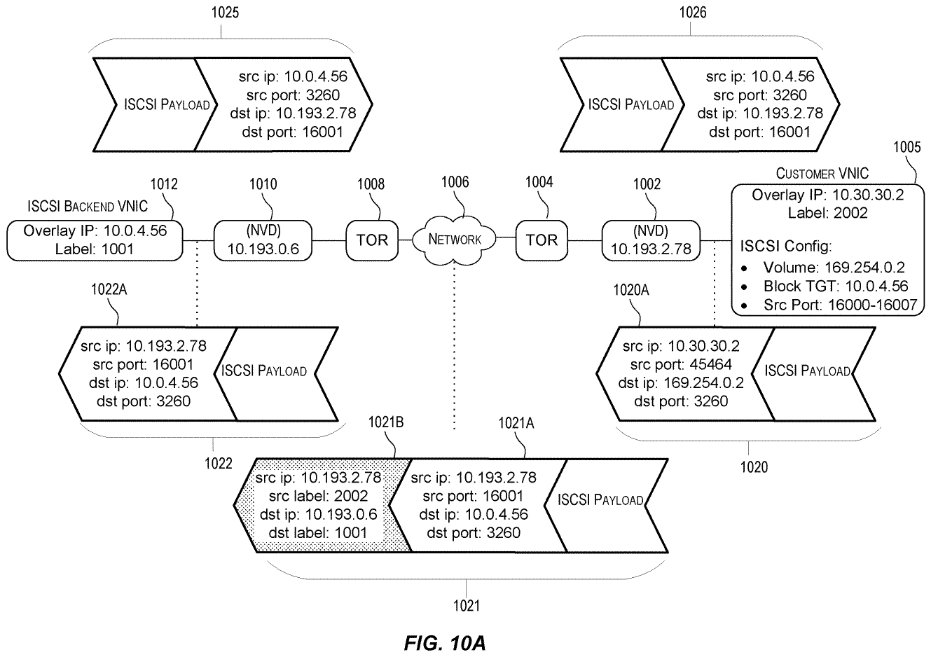

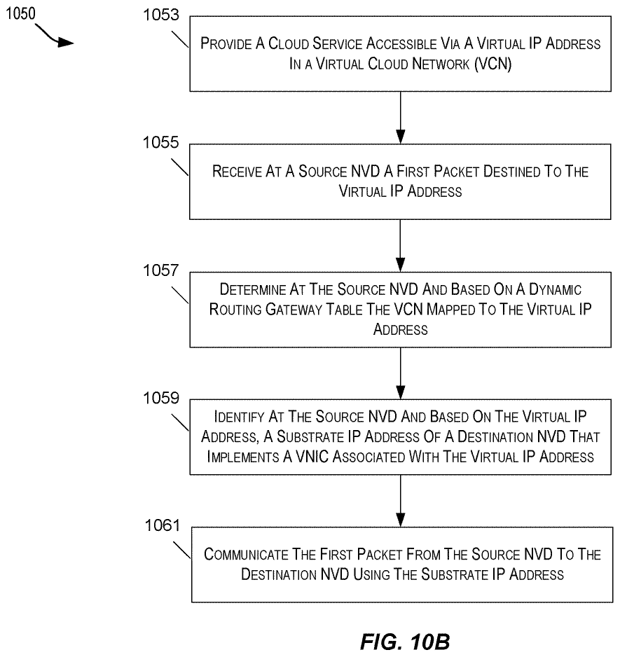

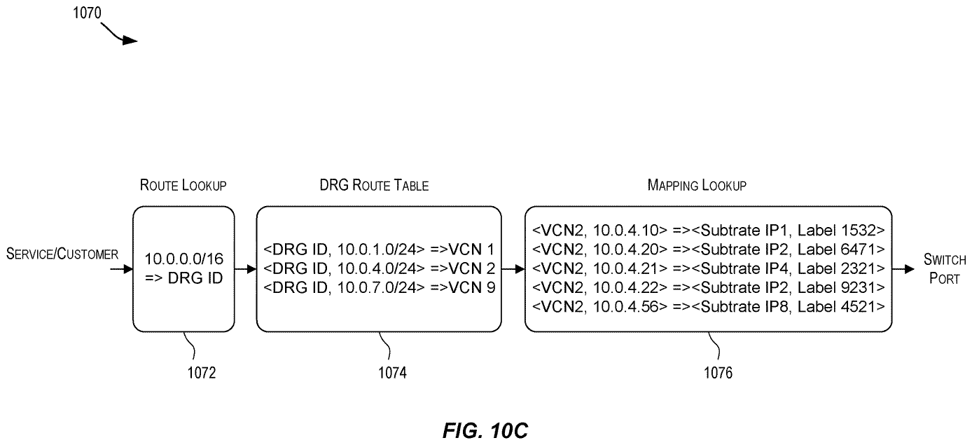

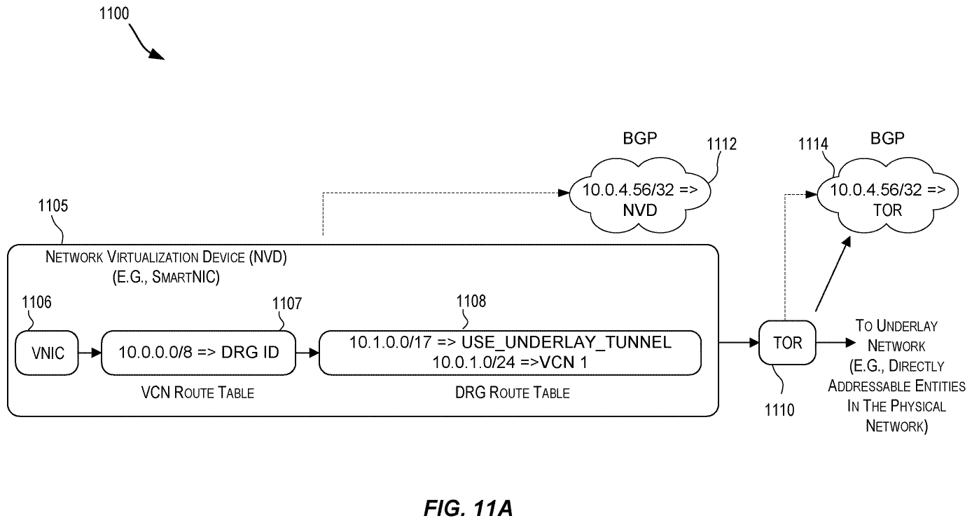

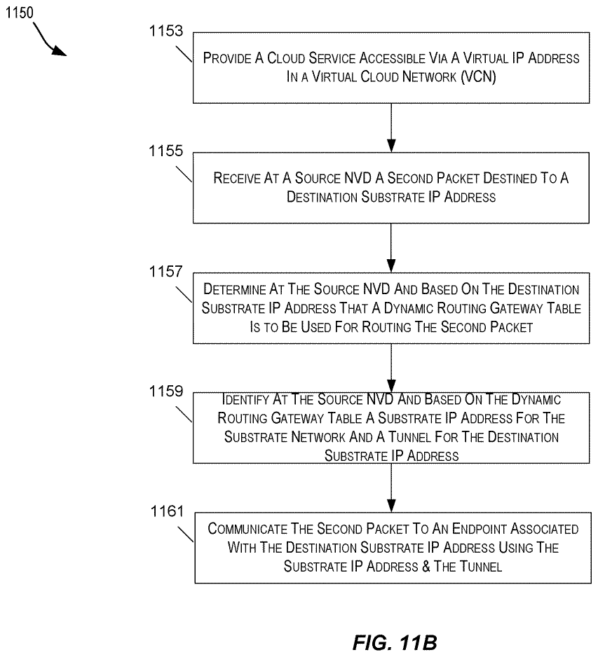

According to some embodiments, each substrate service VCN can have its own route table that defines one or more rules for forwarding network traffic within the reduced footprint data center 900. As shown in FIG. 9, substrate service VCN-1 904 can have VCN-1 route table 910, substrate service VCN-2 906 can have VCN-2 route table 912, and substrate service VCN-N 908 can have VCN-N route table 914. The routing information of each of the substrate service VCNs 904-908 can be initially configured when the reduced footprint data center 900 is first built so that network traffic to/from the core SE services can be routed between the overlay network 902 and the underlay network 922. It is appreciated that different types of traffic may exist in the framework of FIG. 9, such as network traffic from a service VCN to another service VCN (or network traffic from a customer VCN 916 to one of the services VCNs), and network traffic from a service VCN to an endpoint in the underlay network 922. It is noted that the first type of network traffic is referred to herein as an overlay-to-overlay network traffic e.g., source and destination points of the network traffic lie in the overlay network, whereas the second type of network traffic is referred to herein as an overlay-to-underlay network traffic e.g., source being in the overlay network and the destination being in the underlay network (or vice-versa). Details regarding the routing of network traffic are discussed in detail below with references to FIGS. 10A-11B.

Additionally, according to some embodiments, each of the substrate service VCNs is assigned a unique CIDR address (that is non-overlapping with addresses assigned to other service VCNs) for purposes of communicating with the underlay network 922. For example, as shown in FIG. 9, service VCN-1 904 is assigned a CIDR address of 10.0.0.0/24, whereas service VCN-2 906 is assigned a CIDR address of 10.0.1.0/24. It is appreciated that the specific CIDR addresses allocated to the different service VCNs as depicted in FIG. 9 is for illustrative purposes only and is not meant to limit the scope of the present disclosure. Furthermore, by some embodiments, it is noted that only a subset of the plurality of service VCNs depicted in FIG. 9 may be configured to have access to the underlay network 922. This can be provisioned via one or more security rules.

The underlay network 922 can include various devices and other networking endpoints that are connected via the physical networking components of the reduced footprint data center 900. As shown in FIG. 9, the underlay network 922 can include, without limitation, ILOM(s) 924, Bastions 926, NTP server(s) and BIOS services 930, etc. The ILOM(s) 924 (i.e., integrated lights out manager) is a management framework that is primarily used for remote management and monitoring of hardware components of a server. For instance, ILOM 924 may be configured to control power states of the compute instances implemented in the overlay network 902. Additionally, the ILOM(s) 924 can allow for remote management of the associated server devices within the server racks of reduced footprint data center 900.

A Bastion 926 corresponds to a special-purpose server or system that acts as a gateway between an internal network and external networks (e.g., the Internet). It is designed to provide a secure entry point for administrators or users to access private network resources in a controlled and monitored way, while minimizing security risks. The Bastions 926 can be services executing on the server devices of the reduced footprint data center 900 that provide network access via the underlay network 922. The Bastions 926 can provide remote access to computing resources within the reduced footprint data center 900 in conjunction with a Bastion service that operates on the underlay network 922. As such, the Bastion service may be a service that is not moved to the overlay network 902 in the reduced footprint data center 900.

Similarly, network time protocol (NTP) service 928 may operate in the underlay network 922 to provide accurate timing to devices and services within the reduced footprint data center 900. BIOS services can include services that are hosted on the one or more initialization devices on the server racks in the reduced footprint data center 900. For example, BIOS services can include a key encryption service usable to encrypt/decrypt data on the server devices of reduced footprint data center 900 during the initial boot process. As another example, the BIOS services can include a network configuration service that can provide the initial network configuration for devices within the reduced footprint data center 900.

With SE services being moved from the underlay network 922 to the overlay network 902 (i.e., being executed in service VCNs), some of the services may still need network connectivity with the underlay network 922 to properly function (e.g., may need connectivity to ILOM 924). To provide such a connectivity, a substrate access VCN 918 can be implemented within the reduced footprint data center 900. The substrate access VCN 918 can include a dynamic routing gateway (DRG) that provisions communications between the substrate service VCNs 904-908 and the underlay network 922. The substrate access VCN 918 can then have a DRG route table 920 that can define a single route rule for reaching the underlay network 922 from the substrate service VCNs 904-908. For sake of illustration, this is represented in FIG. 9 as the underlay network block 923, which uses 10.1.0.0/17 for all connections that desire to be routed to the underlay network 922.

According to some embodiments, to avoid circular dependencies when the reduced footprint data center 900 is first built or recovers from a shutdown event, an initialization device (e.g., BIOS device 602 of FIG. 6) can be used to configure the network addresses and routes for a substrate access VCN 918 and/or a dynamic route gateway within the substrate access VCN 918. When the server devices of each reduced footprint data center 900 server racks are booted, the substrate access VCN 918 can be deployed to communicatively connect the one or more substrate service VCNs 904-908 with the underlay network 922. The initialization device can send network configuration information to the substrate access VCN 918 to configure the DRG route table 920 to provide initial network addresses (e.g., IP addresses) for each endpoint of the substrate service VCNs 904-908 in the overlay network 902 until a DHCP service (i.e., dynamic host configuration protocol service) and other networking services are available in their respective substrate service VCNs. In addition, the initialization device can send networking configuration information to define one or more static routes for the dynamic routing gateway as part of the DRG routing table 920. The static routes can characterize a networking connection between the underlay network 922, including a SmartNIC connected to each server device of the reduced footprint data center, and each substrate service VCNs 904-908.

FIG. 10A depicts a schematic illustrating network traffic routing from a source in an overlay network to a destination in the overlay network, according to some embodiments. In other words, the schematic illustrated in FIG. 10A corresponds to an overlay-to-overlay network traffic routing scenario. For sake of illustration, the example depicted in FIG. 10A corresponds to the case of a customer 1005 that desires to communicate with backend service (e.g., block storage) 1012. It is appreciated that such a service is now executed on compute instances that are virtualized as opposed to such services being traditionally offered on special service enclaves. Described below is the routing of a data packet that leverages VCNs to access the service. Further, for sake of completeness, it is assumed that the data packet utilizes the iSCSI (i.e., Internet Small Computer Systems Interface) protocol that allows data to be transmitted over a network using the Internet Protocol (IP). As shown in FIG. 10A, the components involved in the transmission of the data packet include a customer VNIC 1005, a first NVD 1002 (e.g., source NVD that supports the customer VNIC), top-of-rack (TOR) switches (1004, 1008), a network 1006 (e.g., fabric network interconnecting the two TORs), a backend VNIC 1012 (associated with the desired service that is to be accessed), and a second NVD 1010 (e.g., destination NVD that supports the backend VNIC).

In operation, when a customer desires to connect with the service provided in one of the services VCNs, the customer VNIC 1005 adds a header to a packet payload and transmits the packet 1020 to the source NVD 1002. As shown in FIG. 10A, the packet 1020 includes the header 1020A which comprises information including a source IP address i.e., address 10.30.30.2 that corresponds to the overlay IP address of the customer VNIC 1005, a source port on which the packet was transmitted, a destination IP address (along with a destination port) corresponding to an IP location from where the desired service may be accessed. It is noted that the destination IP address (represented as 169.254.0.2) may be a link-local address of the particular service i.e., services in a cloud environment may be typically exposed by their respective link local addresses.

Upon the NVD 1002 receiving the data packet transmitted by the customer VNIC 1005, the NVD 1002 performs a series of operations including at least a network address translation operation and an encapsulation operation. As shown in FIG. 10A, the NVD 1002 modifies a header (1020A) of the received packet (1020) to generate a new header 1021A. In this new header, it is noted that the source IP address (and source port) is changed to reflect the NVD 1002 as now being the source of the data packet. With regard to the first operation i.e., the network address translation operation, the NVD 1002 converts the link-local address of the cloud service (represented as 169.254.0.2) to a virtual IP address corresponding to the VNIC associated with the cloud service (i.e., represented as overlay IP address 10.0.4.56). Thus, the modified header 1021A includes as source IP address, the IP address of the NVD 1002, and the overlay IP address of the backend VNIC as the destination IP address.

Further, with respect to the second operation of encapsulation, the NVD 1002 encapsulates the data packet with an encapsulation header (represented as 1021B). The encapsulation header 1021B comprises information including at least the substrate IP address of a destination NVD i.e., NVD 1010 that supports the backend VNIC 1012. It is appreciated that the NVD 1002 performs this operation by utilizing the dynamic routing gateway table to figure out as to where does the virtual IP address 10.0.4.56 live. Specifically, the source NVD 1002 utilizes the DRG table to determine, using a pair of (IP address, label) to ascertain that destination NVD (having address 10.193.0.6) serves the backend VNIC 1012.

Thus, the encapsulation header 1021B of the packet 1021 includes the following information—source IP address corresponding to the IP address of the source NVD 1002, source label (2002) corresponding to the label associated with the customer VNIC 1005, a destination IP address (10.193.0.6) corresponding to the IP address of the destination NVD 1010, and a destination label (1001) corresponding to the label associated with the backend VNIC 1012. It is appreciated that the DRG routing table is pre-configured with information mapping a particular NVD to all the VNICs supported by that particular NVD, as well as information pertaining to pairs of {substrate IP address, label} to determine a particular NVD serving a desired overlay IP address (e.g., IP address of backend VNIC). Further, such pre-configured information may be shared across all NVDs in the system. The NVD 1002 upon completing the network address translation operation and the encapsulation operation, forwards the data packet 1021 to the NVD 1010 over a tunnel established between the source NVD 1002 and the destination NVD 1010.

In turn, the destination NVD i.e., NVD 1010, upon receiving the data packet 1021, removes/discards the encapsulation header 1021B from the packet, and forwards the remaining portion of the packet (i.e., packet 1022 with header represented as 1022A) to the backend VNIC associated with the desired service that is to be accessed. Additionally, it is noted that traffic directed from a service VCN to an NVD (e.g., smartNIC) is going to be virtualized. The NVDs have all mappings of the service VCNs and thus traffic going back to a particular NVD (e.g., source NVD 1002) can always be delivered from the receiving NVD (e.g., destination NVD 1010). In other words, traffic directed from the destination NVD 1010 to the source NVD 1002 is depicted in FIG. 10A as data packets 1025, 1026 that are directed to the destination NVD over the tunnel established between the destination NVD and the source NVD.

FIG. 10B illustrates a flowchart 1050 depicting steps performed by a network virtualization device in executing routing of a data packet (e.g., overlay-to-overlay routing), according to some embodiments. The processing depicted in FIG. 10B may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 10B and described below is intended to be illustrative and non-limiting. Although FIG. 10B depicts the various processing steps occurring in a particular sequence or order, this is not intended to be limiting. In certain alternative embodiments, the steps may be performed in some different order or some steps may also be performed in parallel. By some embodiments, the process depicted in FIG. 10B may be performed by the source NVD 1002 of FIG. 10A.

The process commences in step 1053, where a cloud service that is accessible via a virtual IP address in a virtual cloud network (VCN) is provided to one or more customers. It is noted that the VCN is part of an overlay network e.g., a service VCN as depicted in FIG. 9. In step 1055, a source network virtualization device (NVD) receives a first packet destined to the virtual IP address. For instance, the source NVD may correspond to NVD 1002 of FIG. 10A, where the NVD receives the first packet from the customer VNIC 1005.

The process then moves to step 1057, where the source NVD determines, based upon a dynamic routing gateway table, the VCN mapped to the virtual IP address. Thereafter, in step 1059, the source NVD identifies, based upon the virtual IP address, a substrate IP address of a destination NVD that implements a virtual network interface card (VNIC) associated with the virtual IP address. For instance, referring to FIG. 10A, the source NVD (1002) may identify that NVD 1010 is the destination NVD that implements the VNIC 1012 associated with the virtual IP address of the service. The process in step 1061 communicates the first packet from the source NVD to the destination NVD using the substrate IP address. It is appreciated that in the communication of the packet, the source NVD executes a network address translation operation and an encapsulation operation with respect to the first packet prior to the first packet being transmitted to the destination NVD. The details of the network address translation operation and the encapsulation operation are described previously with reference to FIG. 10A and thus are not repeated herein for sake of repetition.

FIG. 10C illustrates another schematic 1070 illustrating routing performed in an overlay network, according to some embodiments. Specifically, FIG. 10C illustrates the different route lookup tables that are utilized in the transmission of a data packet. As shown in FIG. 10C, the source of the data packet may correspond to a particular customer (e.g., associated with a customer VCN and desiring to access some service), or a service offered in a service VCN (e.g., service provided by a virtualized compute).

As shown in FIG. 10C, upon transmission of the data packet (destined for e.g., IP address space 10.0.0.0/16), a first lookup operation is performed with respect to a first lookup table 1072 (e.g., customer lookup table). According to some embodiments, the first lookup operation performed with respect to the first lookup table 1072 may indicate that the packet is destined for a network (e.g., VCN) which is attached to a DRG. Thus, the packet gets forwarded to the DRG. At the DRG, a second lookup operation is performed with respect to a DRG lookup table 1074. At this step, the packet is evaluated with respect to information included in the DRG lookup table. Upon evaluation, it is identified that the CIDR address included in the packet (i.e., 10.0.0.0/16) corresponds to a particular VCN (e.g., VCN-2). Note, that as stated previously, the DRG is preconfigured with such mappings at bootup.

Upon completing the evaluation with respect to the DRG lookup table 1074, a final lookup operation is executed i.e., with respect to a local mapping table 1076 that is associated with the VCN (e.g., VCN-2) where the packet is destined for. Such an evaluation is required to ensure that the packet is routed to a specific destination (i.e., a specific resource) within the VCN. This is achieved through a lookup operation performed with the mapping lookup table 1076, which includes a mapping of a specific overlay IP address to a combination (i.e., pair) of {substrate IP address, label}. Specifically, the DRG is pre-configured with such information such that for a specific overlay IP address, the DRG can determine what is the corresponding substrate IP address (and label information), where the packet is to be delivered. It is appreciated that the DRG is configured with the mapping information included in the mapping lookup table 1076, as when services get provisioned in the service VCNs in the overlay network, they get attached to the DRG via a DRG control plane. Thus, DRG learns about corresponding IP addresses in a VCN from the VCN control plane. Further, as shown in FIG. 10C, upon completing the lookup operation with respect to the mapping table 1076, the data packet is sent out on a particular switch port i.e., particular port of the TOR switch.

FIG. 11A depicts a schematic 1100 illustrating routing of a data packet from a source in an overlay network to a destination in an underlay network, according to some embodiments. Thus, the schematic of FIG. 11A corresponds to the case of routing a data packet for the overlay-to-underlay scenario as described previously. For instance, the schematic depicted in FIG. 11A may correspond to the case where a service (provided in the overlay network) desires to communicate with an endpoint in the underlay network (e.g., ILOM).

As shown in FIG. 11A, an NVD 1105 desires to communicate a data packet (via a TOR switch 1110) to an endpoint in the underlay network. The VNIC 1106 that is supported by the NVD 1105 and associated with the particular service in the overlay network, transmits a packet with destination information (e.g., 10.0.0.0/8) corresponding to the endpoint in the underlay network. In operation, a first lookup operation is performed with respect to the VCN route table 1107, where it is identified that the destination lies in the underlay network and thus the packet is to be forwarded to the DRG.

Based upon the destination information (i.e., destination substrate IP address), a dynamic routing gateway table that is executed on the NVD 1105, is used for routing the packet. Specifically, another lookup operation is performed with respect to the dynamic routing gateway table 1108, where a substrate IP address for the substrate network (e.g., 10.1.0.0/17) and a tunnel are identified for the endpoint in the underlay network. Note that according to some embodiments, the DRG may utilize the IP address space 10.1.0.0/17 for all connections that are to be routed from the overlay network to the underlay network. Further, the data packet is communicated to the endpoint associated with the destination substrate IP address using the substrate IP address for the substrate network and the tunnel.

Additionally, according to some embodiments, all NVDs announce (e.g., via BGP) their overlay CIDR address information to the underlay network components in order to enable the underlay network components to communicate back with the overlay network. For instance, as shown in FIG. 11A, the NVD 1105 advertises the CIDR address information (e.g., 10.0.4.56/32) to the TOR switch 1110. The TOR switch 1110 in turn, propagates the advertised information (e.g., via BGP) to all downstream entities e.g., entities included in the underlay network. It is noted that the entities included in the underlay network can be directly addressable on the physical network e.g., console servers, DHCP servers, etc. The BGP advertisements made by the NVD to the TOR switch 1110 is depicted in FIG. 11A as block 1112, whereas the propagation of the advertised routes by the TOR switch 1110 to the underlay components is depicted by block 1114. In this manner, any underlay component that desires to communicate with an overlay service may forward its data packets to the corresponding TOR, which in turn can forward the data packets to the specific service.

Turning now to FIG. 11B, there is illustrated a flowchart 1150 depicting steps performed by a network virtualization device in executing routing of a packet, according to some embodiments. The processing depicted in FIG. 11B may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 11B and described below is intended to be illustrative and non-limiting. Although FIG. 11B depicts the various processing steps occurring in a particular sequence or order, this is not intended to be limiting. In certain alternative embodiments, the steps may be performed in some different order or some steps may also be performed in parallel. By some embodiments, the process depicted in FIG. 11B may be performed by the NVD 1105 of FIG. 11A in communicating a data packet to an endpoint in the underlay network.

The process commences in step 1153, where a cloud service that is accessible via a virtual IP address in a virtual cloud network (VCN) is provided to one or more customers. It is noted that the VCN is part of an overlay network e.g., a service VCN as depicted in FIG. 9. Thereafter, a source NVD (e.g., NVD 1105 of FIG. 11A) receives a data packet (e.g., a second packet) destined to a destination substrate IP address (step 1155). The destination substrate IP address is associated with an endpoint in a substrate network e.g., ILOM. Thus, this form of communicating the data packet corresponds to the case of overlay-to-underlay communication.

The process then moves to step 1157, where the source NVD determines, based upon the destination substrate IP address, that the dynamic routing gateway table executed on the source NVD is to be used for routing the second packet. In step 1159, the source NVD identifies, based upon the dynamic routing gateway table, a substrate IP address for the substrate network and a tunnel for the destination substrate IP address. This corresponds to the processing performed with lookup operation evaluated with respect to the dynamic routing gateway table as described previously with reference to FIG. 11A. The process then moves to step 1161, where the second packet is communicated to the endpoint associated with the destination substrate IP address using the substrate IP address for the substrate network and the tunnel. It is noted that the source NVD also advertises CIDR addresses (e.g., VCN address associated with the source NVD) to a top-of-rack (TOR) switch. The TOR switch further propagates the CIDR addresses to all endpoints included in the underlay (i.e., substrate) network. This enables the endpoints in the underlay network to communicate back with services in the overlay network.

The present disclosure provides a number of advantages. For instance, as opposed to providing services in the substrate (i.e., underlay) network, aspects of the present disclosure partition a traditional substrate network into two networks, the service network, where CSP services run in traditional overlay VCNs, and an underlay network where the remaining physical network endpoints that cannot be virtualized (e.g., ILOMs) reside. Former CSP substrate services are moved/migrated to VCNs in their own tenancy and utilize DRG peering to a central networking-administered DRG to communicate with other services and the underlay network. Thus, when a service wants to expand, as opposed to the traditional mechanism of deploying service enclave racks that consume space and incur more processing complexity and costs, by aspects of the present disclosure, services may be provisioned in the overlay network by allocating capacity from an available compute instance pool. It is appreciated that services running in the overlay need the following features for discovery, reachability, and customer management: (a) services need access to other services for accessing control planes, posting metrics, posting logs, etc., and (b) services which use anycast addresses in the substrate need a replacement to anycast for reachability and effective cluster utilization.

As the customer model depicted in FIG. 9 does not support anycast IP addressing, by one embodiment of the present disclosure, there is provided a new framework (referred to herein as ‘service endpoint groups’) to achieve the anycast feature. Specifically, the butterfly regions rely on NVD-based endpoint selection to forward traffic to multi-homed participants in the customer network virtualization. The service endpoint groups provision for: (a) ability to group overlay endpoints together as a group, (b) ability to associate these groups to gateways and VNICs in a customer VCN, and (c) ability to select a new endpoint from the group for new workflows to be sent to the gateway/VNIC. In one implementation, for a given virtual IP address in a virtual network, an equal cost multi-path (ECMP) group is provided that points to a list of IP addresses. It is appreciated that each IP in the list of IP addresses corresponds to an endpoint in the substrate service access VCNs. In other words, an overlay ECMP group is configured in the route table of the VCN such that the functionality of anycasting can be achieved.

### Networking Services

The networking architecture described above with reference to FIG. 9 allows all services to migrate to the overlay layer and leverage networking foundations in order to keep the current business logic for cross-service communication as well as communication to the underlay network. In what follows, there is described with reference to FIG. 12, a networking architecture that leverages the dynamic routing gateway (DRG) in the overlay network.

FIG. 12 depicts an exemplary schematic architecture 1200 depicting usage of a DRG in achieving network connectivity between different services when migrated to the overlay layer. It is appreciated that in the description of FIG. 12, a network load balancing (NLB) control plane is considered as an example service that is migrated to the overlay layer. However, it is understood that this is no way limiting the scope of the present disclosure and that the concepts described with reference to FIG. 12 are equally applicable to other control plane services.

FIG. 12 depicts a substrate access VCN (hosting a DRG) 1205, an NLB control plane service 1209, a VNICaaS service 1212, a SPLAT service 1235, dependent services in the overlay 1210, a zero trust bastion server 1214, an underlay network block 1207, and underlay network services 1224, 1226, and 1230. It is noted that the NLB control plane service 1209, VNICaaS 1212, etc., correspond to control plane services that are provided in the overlay layer (i.e., as opposed to being provided in the substrate layer) in the networking architecture of FIG. 12.

It is appreciated that similar to the description of FIG. 9, the substrate access DRG 1205 can provide communications between the overlay services (e.g., NLB control plane service 1209) and an underlay network 1222. Specifically, a DRG route table 920 can be configured that defines a single route rule for reaching the underlay network 1222 from the services in the overlay. For sake of illustration, this is represented in FIG. 12 as the underlay network block 1207, which uses 10.1.0.0/17 for all connections that desire to be routed to the underlay network 1222. The underlay network 1222 can include various devices and other networking endpoints that are connected via the physical networking components of the reduced footprint data center. As described previously with reference to FIG. 9, the underlay network 1222 can include, without limitation, ILOM(s) 1224, Bastions 1226, NTP server(s) and BIOS services 1230, etc. A description of these components is provided previously with reference to FIG. 9 and thus is not repeated here.

A primary task of the NLB control plane service 1209 is to generate mappings and transmit them to an NLB data plane. The NLB data plane can be executed on top of VNIC as a service (i.e., VNICaaS) control plane 1212. In some implementations, the NLB control plane service 1209, the VNICaaS 1212, as well as the DRG 1205 are executed on a smartNIC. In this setting, the DRG 1205 provides direct connectivity (in the overlay layer) from the NLB control plane service 1209 to the VNICaaS 1212 i.e., the mappings are transmitted from the NLB control plane service 1209 to the VNICaaS 1212 via the DRG 1205. In some implementations, the NLB control plane service 1209 includes a service gateway 1242. The service gateway 1242 can be utilized by the NLB control plane service 1209 to achieve direct connectivity to one or more services (e.g., dependent services 1210) that are already deployed in the overlay layer. The one or more dependent services 1210 may include a plurality of services e.g., service 1 (1210A), service 2 (1210B), . . . , service K (1210K). Such dependent services may correspond to a PKI service, a certificate service, a compute instance service, workflow as service, object storage services, or the like. It is appreciated that such services may be availed by the NLB control plane service 1209 directly via the service gateway 1242 i.e., not using the DRG 1205.

According to some embodiments, a service platform of a CSP (e.g., Oracle) refers to a broad, integrated suite of managed Platform-as-a-Service (PaaS) and Software-as-a-Service (SaaS) offerings. Such a platform enables developers to build, deploy, manage, and scale applications, databases, AI, and integration workflows without managing underlying servers. In FIG. 12, a service platform (i.e., SPLAT) service 1235 is provided in the overlay network. The SPLAT service 1235 includes an Internet Gateway 1240, which provides an entry point for external customers to issue a SPLAT request (e.g., an NLB request). Such a request can be routed from the SPLAT service 1235 to the NLB control plane service 1209 via the DRG 1205. Further, as shown in FIG. 12, the network architecture 1200 includes a server (e.g., a zero-trust Bastion server) 1214 that is deployed in the overlay layer. The server 1214 is provisioned with an Internet gateway 1242 that provides a point of entry for external customer(s) to achieve connectivity (e.g., via the DRG 1205) to different control plane services (e.g., NLB control plane service 1209) deployed in the overlay layer. Thus, the DRG 1205 provides direct connectivity across different networking data/control planes, gateways, etc., in the overlay layer (i.e., via direct smartNIC to smartNIC communication) in a manner similar to the connectivity that the entities would have if they were deployed in the substrate/underlay layer of the network.

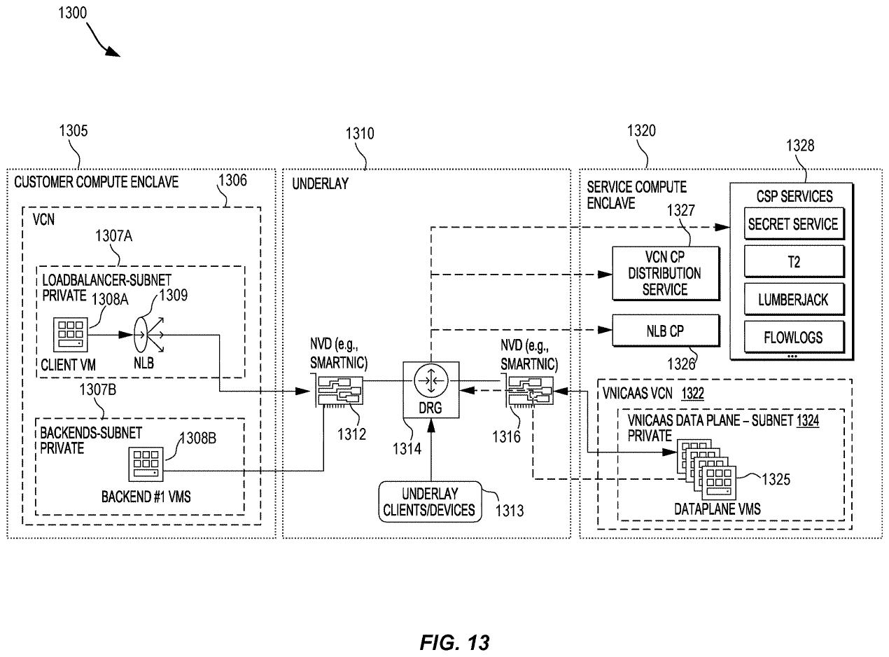

FIG. 13 depicts another exemplary networking architecture 1300 utilizing the DRG to achieve connectivity between a substrate and an overlay network layer, according to certain embodiments. FIG. 13 depicts a customer compute enclave 1305, an underlay layer 1310, and an overlay layer (i.e., service compute enclave) 1320. The customer compute enclave 1305 includes a customer VCN 1306 that comprises a customer's private subnet 1307A and a customer's backend subnet 1307B. The private subnet 1307A includes one or more customer virtual machines (VMs) 1308A and a network load balancer 1309, whereas the customer's backend subnet 1307B includes backend VMs 1308B.

The underlay layer 1310 includes a first NVD (e.g., smartNIC) 1312, a DRG 1314, and a second NVD 1316. The first NVD 1312 is also referred to herein as a source NVD as it is communicatively coupled with the client VM 1308A in the customer VCN 1306, and the second NVD 1316 is referred to herein as a destination NVD as it is communicatively coupled to the VNICaaS VCN 1322 in the overlay layer 1320. In the networking model of FIG. 13, different networking data planes, control planes, and other services are provided in the overlay layer 1320. For instance, the VNICaaS data plane 1324 (which includes one or more data plane VMs 1325), an NLB control plane 1326, VNICaaS control plane 1327, and other CSP provided services 1328 (e.g., secret service, lumberjack service, flow log service, etc.,) are provided in the overlay layer (as opposed to being provided in the substrate layer).

The networking model 1300 of FIG. 13 utilizes the DRG 1314 to transmit packets from a client VM 1308A (i.e., in the customer's compute enclave 1306) to a data plane VM 1325 that is included in the VNICaaS data plane included in the overlay layer 1320. As will be described below, the DRG 1314 provides consistent networking connectivity across the different networking data planes and services provided in the overlay layer 1320. For example, the VNICaaS data plane is directly coupled with services provided in the overlay layer 1320 (e.g., NLB control plane 1326, CSP services 1328, VCN CP 1327) via the DRG 1314. The DRG 1314 also provides connectivity to services and client devices 1313 deployed in the underlay layer 1310.

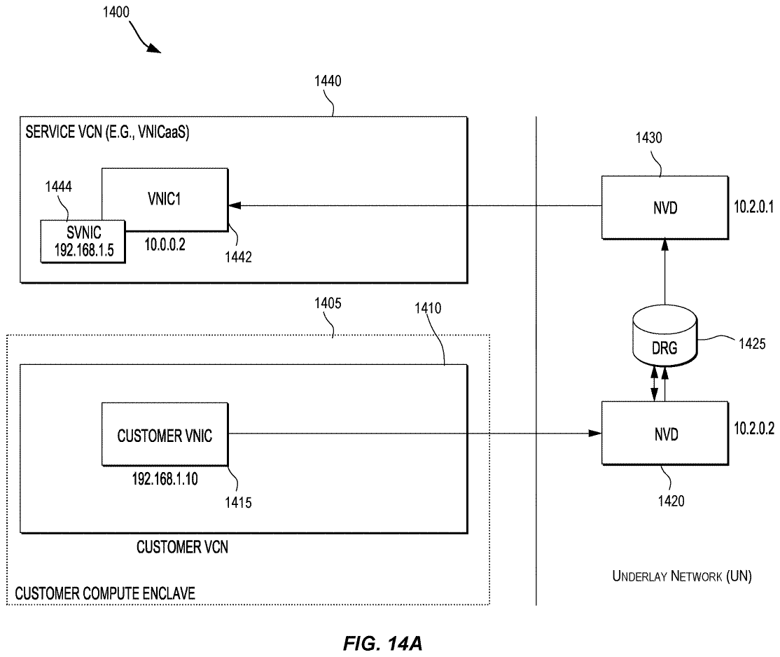

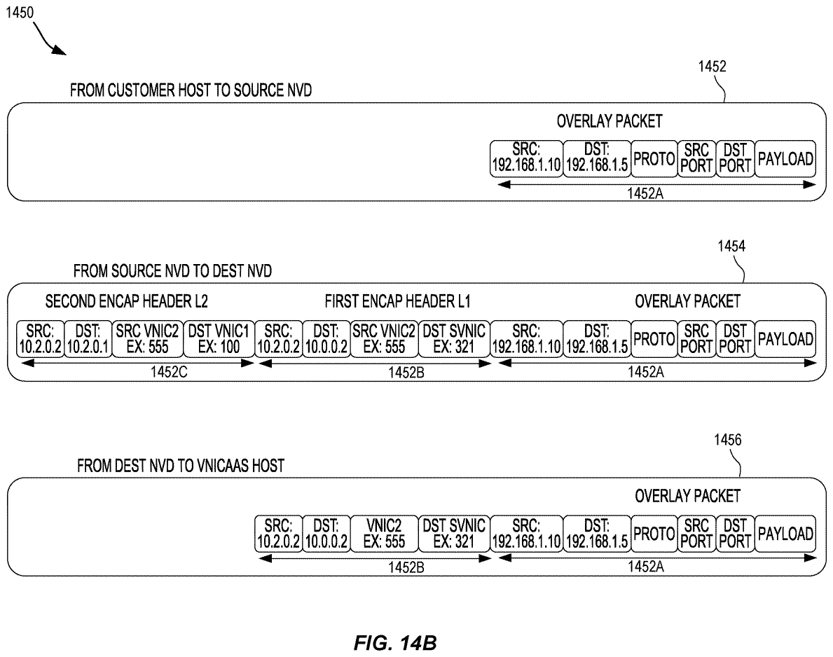

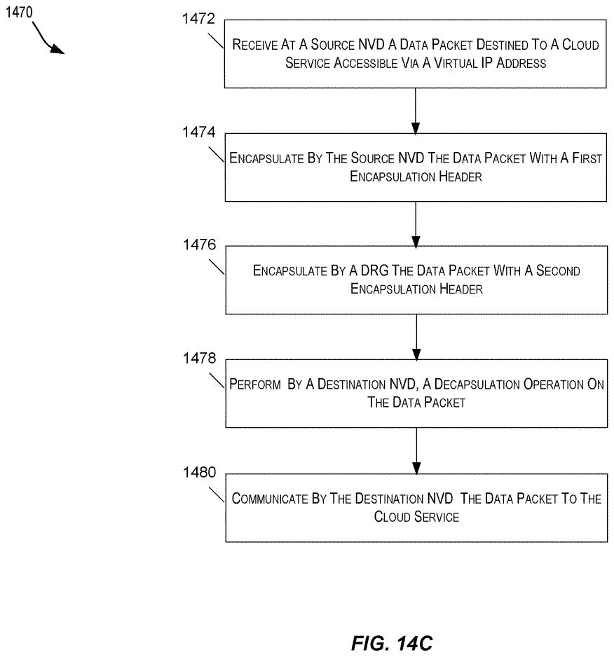

According to some embodiments, the DRG 1314 is leveraged in order to establish connectivity from the client VM 1308A to a data plane service (e.g., VNICaaS data plane 1324) that is provided in the overlay layer 1320. For example, a packet is transmitted from the client VM to the source NVD 1312. The source NVD 1312 encapsulates the received data packet (e.g., inserts a first encapsulation header) and forwards the packet to the DRG 1314. The DRG 1314 in turn performs another encapsulation operation (i.e., inserts a second encapsulation header) and forwards the data packet to the destination NVD 1316. The destination NVD 1316 can be configured to execute a decapsulation operation and forward the packet to the VNICaaS data plane 1324. In turn, the VNICaaS data plane 1324 can be configured to execute another decapsulation operation and further process the packet. For example, the VNICaaS data plane 1324 can communicate with control plane services and other services provided in the overlay layer 1320 and forward the data packet to customer's backend subnet 1307B based on NLB policies retrieved from the NLB control plane 1326. A detailed example describing a step to step encapsulation/decapsulation operations performed by the entities in FIG. 13 is described next with references to FIG. 14A and FIG. 14B.

FIG. 14A depicts an exemplary connection established from a customer's compute instance to a service executed in the overlay layer, according to certain embodiments and FIG. 14B depicts exemplary packets that are transmitted in the connection established of FIG. 14A. FIG. 14A depicts a customer VCN 1410 included in a customer compute enclave 1405. The customer VCN 1410 includes a customer VNIC 1415 that is associated with a customer's VM (not shown). The customer's VNIC is assumed to have an IP address of 192.168.1.10. In the example depicted in FIG. 14, it is considered that the customer's VNIC 1415 desires to communicate with a service VCN 1440 e.g., VNICaaS, that is provided in the overlay layer.

As shown in FIG. 14A, an underlay layer of the network includes a first NVD 1420 (also referred to herein as source NVD) having an IP address of 10.2.0.2, a DRG 1425, and a second NVD 1430 (also referred to herein as destination NVD) having an IP address of 10.2.0.1. The service VCN 1440 includes a VNIC 1442 (associated with a customer's VM) having an IP address of 10.0.0.2. The VNIC 1142 may be associated with a smart VNIC (i.e., SVNIC) 1444 having an IP address of 192.168.1.5.

In operation, the customer VNIC 1415 transmits a packet (destined for the service VCN 1440) to the source NVD 1420. An exemplary packet transmitted by the customer's VNIC to the source NVD is depicted as packet 1452 in FIG. 14B. As shown in FIG. 14B, the packet 1452 comprises information 1452A including IP address of a source of the packet (e.g., IP address of the customer VNIC 1415), an IP address of a destination of the packet (e.g., IP address of the SVNIC 1444), a protocol implemented for the communication, a source port of transmitting the packet, a destination port where the packet is to be received, and payload information.

The source NVD 1420 upon receiving the data packet 1452 executes an encapsulation operation. Specifically, the source NVD 1420 encapsulates the data packet with a first encapsulation header to generate a first encapsulated data packet. The first encapsulated data packet is then forwarded to the DRG 1425. Referring to FIG. 14B, packet labeled 1454 represents the first encapsulated data packet. The first encapsulated data packet 1454 includes the information 1452A included in the original packet as well includes a first encapsulation header labeled as 1452B. The first encapsulation header 1452B includes information identifying at least a source of the first encapsulated data packet i.e., the source NVD 1420 having IP address 10.2.0.2, and a destination of the first encapsulated data packet i.e., the VNIC 1442 associated with the cloud service and having IP address 10.0.0.2. The packet 1454 is then forwarded to the DRG 1425 to be forwarded to the destination NVD 1430.

According to some embodiments, the DRG 1425 executes another encapsulation operation to generate a second encapsulated data packet. Specifically, the DRG encapsulates the first encapsulated data packet with a second encapsulation header to generate a second encapsulated data packet, which is forwarded to destination NVD 1430 associated with the cloud service provided in the overlay layer. As shown in FIG. 14B, the packet 1454 includes the second encapsulation header labeled 1452C, which includes information identifying at least a source of the data packet i.e., the source NVD 1420 having IP address 10.2.0.2, and a destination of the data packet i.e., the destination NVD 1430 having IP address 10.2.0.1.

Upon the DRG 1425 performing the second encapsulation operation, the packet 1454 is forwarded to the destination NVD 1430. The destination NVD 1430 in turn executes a first decapsulation operation i.e., the NVD 1430 removes the second encapsulation header 1452C from the second encapsulated data packet 1454 to obtain the first encapsulated data packet i.e., packet represented as 1456 in FIG. 14B. The destination NVD 1430 forwards the packet 1456 to the host machine executing the VNIC 1442. The VNIC 1442 in turn performs another decapsulation operation, wherein the VNIC 1442 removes the first encapsulation header 1452B from the packet 1456 to process the packet based on one or more business logic criteria. In this manner, the original packet transmitted from the customer's VM is received by the service executed in the overlay layer.

Turning now to FIG. 14C, there is illustrated a flowchart 1470 depicting steps performed in executing routing of a packet, according to some embodiments. The processing depicted in FIG. 14C may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 14C and described below is intended to be illustrative and non-limiting. Although FIG. 14C depicts the various processing steps occurring in a particular sequence or order, this is not intended to be limiting. In certain alternative embodiments, the steps may be performed in some different order or some steps may also be performed in parallel. By some embodiments, the process depicted in FIG. 14C may be performed by entities included in the underlay layer (e.g., DRG, source/destination NVDs) of FIG. 13.

As stated previously, embodiments of the present disclosure provide for a cloud service (e.g., VNICaaS) that is accessible via a virtual IP address in a virtual cloud network (VCN) to one or more customers. It is noted that the VCN is part of an overlay network e.g., a service VCN as depicted in FIG. 13. A client VM (e.g., client VM 1308 that is deployed in a customer compute enclave) may desire to communicate with such a service.

In step 1472, a source NVD that is communicatively coupled with the client VM receives a data packet that is destined for the cloud service accessible via the virtual IP address. The source NVD encapsulates the data packet with a first encapsulation header to generate a first encapsulated data packet. The first encapsulated data packet is forwarded to a dynamic routing gateway (DRG). Referring to FIG. 14A, an example of such a packet transmission corresponds to a data packet transmitted by the customer VNIC 1415 to the source NVD 1420. An exemplary data packet including the first encapsulation header is depicted as packet 1454 in FIG. 14B.

In the step 1476, the DRG further executes another encapsulation operation on the first encapsulated data packet. Specifically, the DRG encapsulates the data packet with a second encapsulation header to generate a second encapsulated data packet. The second encapsulated data packet is forwarded to destination NVD associated with the cloud service. Referring to FIG. 14A, an example of such a packet transmission corresponds to a data packet transmitted by the source NVD 1420 to the destination NVD 1430. An exemplary data packet including the second encapsulation header is depicted as packet 1454 in FIG. 14B.

In step 1478, the destination NVD upon receiving the data packet of step 1476, proceeds to execute a decapsulation operation. Specifically, the destination NVD decapsulates the second encapsulated data packet to obtain the first encapsulated data packet. An exemplary data packet including corresponding to the data packet after executing the decapsulation operation of the destination NVD is depicted as packet 1456 in FIG. 14B. Upon performing the decapsulation operation, the destination NVD communicates the data packet to the cloud service (step 1480). For example, referring to FIG. 14A, the destination NVD 1430 forwards the data packet to the VNIC 1442 that is associated with the cloud service. The VNIC 1442 may be configured to execute another decapsulation operation, wherein the VNIC removes the first encapsulation header from the data packet and processes the packet based on one or more business logic criterion.

### Example Cloud Infrastructure Embodiment

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

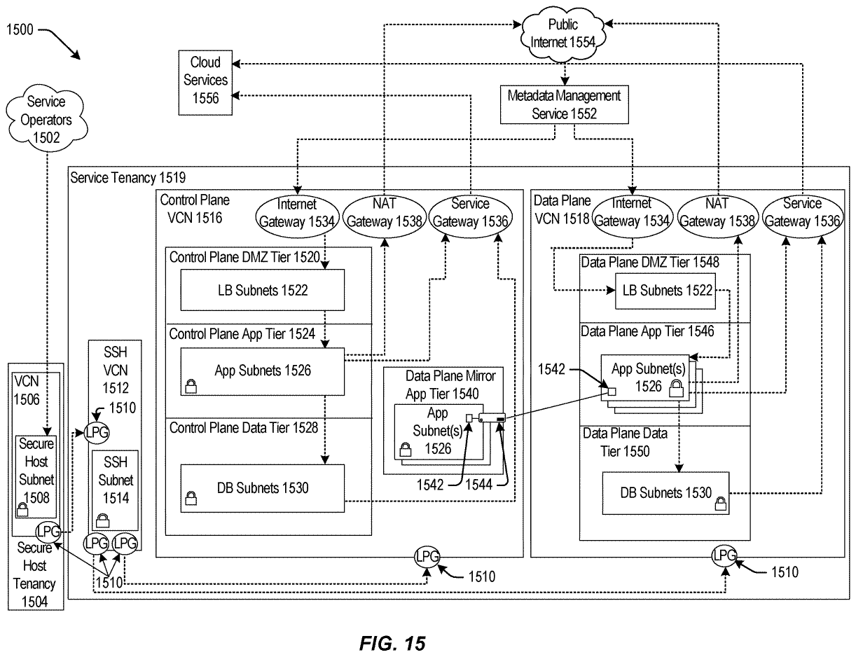

FIG. 15 is a block diagram 1500 illustrating an example pattern of an IaaS architecture, according to at least one embodiment. Service operators 1502 can be communicatively coupled to a secure host tenancy 1504 that can include a virtual cloud network (VCN) 1506 and a secure host subnet 1508. In some examples, the service operators 1502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1506 and/or the Internet.

The VCN 1506 can include a local peering gateway (LPG) 1510 that can be communicatively coupled to a secure shell (SSH) VCN 1512 via an LPG 1510 contained in the SSH VCN 1512. The SSH VCN 1512 can include an SSH subnet 1514, and the SSH VCN 1512 can be communicatively coupled to a control plane VCN 1516 via the LPG 1510 contained in the control plane VCN 1516. Also, the SSH VCN 1512 can be communicatively coupled to a data plane VCN 1518 via an LPG 1510. The control plane VCN 1516 and the data plane VCN 1518 can be contained in a service tenancy 1519 that can be owned and/or operated by the IaaS provider.

The control plane VCN 1516 can include a control plane demilitarized zone (DMZ) tier 1520 that acts as a perimeter network (e.g., portions of a corporate network between the corporate intranet and external networks). The DMZ-based servers may have restricted responsibilities and help keep breaches contained. Additionally, the DMZ tier 1520 can include one or more load balancer (LB) subnet(s) 1522, a control plane app tier 1524 that can include app subnet(s) 1526, a control plane data tier 1528 that can include database (DB) subnet(s) 1530 (e.g., frontend DB subnet(s) and/or backend DB subnet(s)). The LB subnet(s) 1522 contained in the control plane DMZ tier 1520 can be communicatively coupled to the app subnet(s) 1526 contained in the control plane app tier 1524 and an Internet gateway 1534 that can be contained in the control plane VCN 1516, and the app subnet(s) 1526 can be communicatively coupled to the DB subnet(s) 1530 contained in the control plane data tier 1528 and a service gateway 1536 and a network address translation (NAT) gateway 1538. The control plane VCN 1516 can include the service gateway 1536 and the NAT gateway 1538.

The control plane VCN 1516 can include a data plane mirror app tier 1540 that can include app subnet(s) 1526. The app subnet(s) 1526 contained in the data plane mirror app tier 1540 can include a virtual network interface controller (VNIC) 1542 that can execute a compute instance 1544. The compute instance 1544 can communicatively couple the app subnet(s) 1526 of the data plane mirror app tier 1540 to app subnet(s) 1526 that can be contained in a data plane app tier 1546.

The data plane VCN 1518 can include the data plane app tier 1546, a data plane DMZ tier 1548, and a data plane data tier 1550. The data plane DMZ tier 1548 can include LB subnet(s) 1522 that can be communicatively coupled to the app subnet(s) 1526 of the data plane app tier 1546 and the Internet gateway 1534 of the data plane VCN 1518. The app subnet(s) 1526 can be communicatively coupled to the service gateway 1536 of the data plane VCN 1518 and the NAT gateway 1538 of the data plane VCN 1518. The data plane data tier 1550 can also include the DB subnet(s) 1530 that can be communicatively coupled to the app subnet(s) 1526 of the data plane app tier 1546.

The Internet gateway 1534 of the control plane VCN 1516 and of the data plane VCN 1518 can be communicatively coupled to a metadata management service 1552 that can be communicatively coupled to public Internet 1554. Public Internet 1554 can be communicatively coupled to the NAT gateway 1538 of the control plane VCN 1516 and of the data plane VCN 1518. The service gateway 1536 of the control plane VCN 1516 and of the data plane VCN 1518 can be communicatively coupled to cloud services 1556.

In some examples, the service gateway 1536 of the control plane VCN 1516 or of the data plane VCN 1518 can make application programming interface (API) calls to cloud services 1556 without going through public Internet 1554. The API calls to cloud services 1556 from the service gateway 1536 can be one-way: the service gateway 1536 can make API calls to cloud services 1556, and cloud services 1556 can send requested data to the service gateway 1536. But, cloud services 1556 may not initiate API calls to the service gateway 1536.

In some examples, the secure host tenancy 1504 can be directly connected to the service tenancy 1519, which may be otherwise isolated. The secure host subnet 1508 can communicate with the SSH subnet 1514 through an LPG 1510 that may enable two-way communication over an otherwise isolated system. Connecting the secure host subnet 1508 to the SSH subnet 1514 may give the secure host subnet 1508 access to other entities within the service tenancy 1519.

The control plane VCN 1516 may allow users of the service tenancy 1519 to set up or otherwise provision desired resources. Desired resources provisioned in the control plane VCN 1516 may be deployed or otherwise used in the data plane VCN 1518. In some examples, the control plane VCN 1516 can be isolated from the data plane VCN 1518, and the data plane mirror app tier 1540 of the control plane VCN 1516 can communicate with the data plane app tier 1546 of the data plane VCN 1518 via VNICs 1542 that can be contained in the data plane mirror app tier 1540 and the data plane app tier 1546.

In some examples, users of the system, or customers, can make requests, for example create, read, update, or delete (CRUD) operations, through public Internet 1554 that can communicate the requests to the metadata management service 1552. The metadata management service 1552 can communicate the request to the control plane VCN 1516 through the Internet gateway 1534. The request can be received by the LB subnet(s) 1522 contained in the control plane DMZ tier 1520. The LB subnet(s) 1522 may determine that the request is valid, and in response to this determination, the LB subnet(s) 1522 can transmit the request to app subnet(s) 1526 contained in the control plane app tier 1524. If the request is validated and requires a call to public Internet 1554, the call to public Internet 1554 may be transmitted to the NAT gateway 1538 that can make the call to public Internet 1554. Metadata that may be desired to be stored by the request can be stored in the DB subnet(s) 1530.

In some examples, the data plane mirror app tier 1540 can facilitate direct communication between the control plane VCN 1516 and the data plane VCN 1518. For example, changes, updates, or other suitable modifications to configuration may be desired to be applied to the resources contained in the data plane VCN 1518. Via a VNIC 1542, the control plane VCN 1516 can directly communicate with, and can thereby execute the changes, updates, or other suitable modifications to configuration to, resources contained in the data plane VCN 1518.

In some embodiments, the control plane VCN 1516 and the data plane VCN 1518 can be contained in the service tenancy 1519. In this case, the user, or the customer, of the system may not own or operate either the control plane VCN 1516 or the data plane VCN 1518. Instead, the IaaS provider may own or operate the control plane VCN 1516 and the data plane VCN 1518, both of which may be contained in the service tenancy 1519. This embodiment can enable isolation of networks that may prevent users or customers from interacting with other users', or other customers', resources. Also, this embodiment may allow users or customers of the system to store databases privately without needing to rely on public Internet 1554, which may not have a desired level of threat prevention, for storage.

In other embodiments, the LB subnet(s) 1522 contained in the control plane VCN 1516 can be configured to receive a signal from the service gateway 1536. In this embodiment, the control plane VCN 1516 and the data plane VCN 1518 may be configured to be called by a customer of the IaaS provider without calling public Internet 1554. Customers of the IaaS provider may desire this embodiment since database(s) that the customers use may be controlled by the IaaS provider and may be stored on the service tenancy 1519, which may be isolated from public Internet 1554.

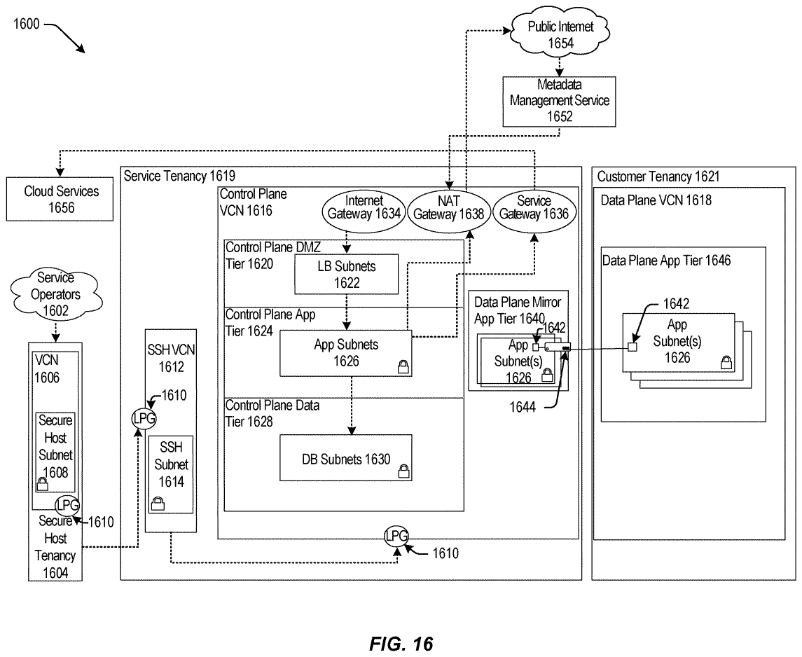

FIG. 16 is a block diagram 1600 illustrating another example pattern of an IaaS architecture, according to at least one embodiment. Service operators 1602 (e.g., service operators 1502 of FIG. 15) can be communicatively coupled to a secure host tenancy 1604 (e.g., the secure host tenancy 1504 of FIG. 15) that can include a virtual cloud network (VCN) 1606 (e.g., the VCN 1506 of FIG. 15) and a secure host subnet 1608 (e.g., the secure host subnet 1508 of FIG. 15). The VCN 1606 can include a local peering gateway (LPG) 1610 (e.g., the LPG 1510 of FIG. 15) that can be communicatively coupled to a secure shell (SSH) VCN 1612 (e.g., the SSH VCN 1512 of FIG. 15) via an LPG 1510 contained in the SSH VCN 1612. The SSH VCN 1612 can include an SSH subnet 1614 (e.g., the SSH subnet 1514 of FIG. 15), and the SSH VCN 1612 can be communicatively coupled to a control plane VCN 1616 (e.g., the control plane VCN 1516 of FIG. 15) via an LPG 1610 contained in the control plane VCN 1616. The control plane VCN 1616 can be contained in a service tenancy 1619 (e.g., the service tenancy 1519 of FIG. 15), and the data plane VCN 1618 (e.g., the data plane VCN 1518 of FIG. 15) can be contained in a customer tenancy 1621 that may be owned or operated by users, or customers, of the system.

The control plane VCN 1616 can include a control plane DMZ tier 1620 (e.g., the control plane DMZ tier 1520 of FIG. 15) that can include LB subnet(s) 1622 (e.g., LB subnet(s) 1522 of FIG. 15), a control plane app tier 1624 (e.g., the control plane app tier 1524 of FIG. 15) that can include app subnet(s) 1626 (e.g., app subnet(s) 1526 of FIG. 15), a control plane data tier 1628 (e.g., the control plane data tier 1528 of FIG. 15) that can include database (DB) subnet(s) 1630 (e.g., similar to DB subnet(s) 1530 of FIG. 15). The LB subnet(s) 1622 contained in the control plane DMZ tier 1620 can be communicatively coupled to the app subnet(s) 1626 contained in the control plane app tier 1624 and an Internet gateway 1634 (e.g., the Internet gateway 1534 of FIG. 15) that can be contained in the control plane VCN 1616, and the app subnet(s) 1626 can be communicatively coupled to the DB subnet(s) 1630 contained in the control plane data tier 1628 and a service gateway 1636 (e.g., the service gateway 1536 of FIG. 15) and a network address translation (NAT) gateway 1638 (e.g., the NAT gateway 1538 of FIG. 15). The control plane VCN 1616 can include the service gateway 1636 and the NAT gateway 1638.

The control plane VCN 1616 can include a data plane mirror app tier 1640 (e.g., the data plane mirror app tier 1540 of FIG. 15) that can include app subnet(s) 1626. The app subnet(s) 1626 contained in the data plane mirror app tier 1640 can include a virtual network interface controller (VNIC) 1642 (e.g., the VNIC of 1542) that can execute a compute instance 1644 (e.g., similar to the compute instance 1544 of FIG. 15). The compute instance 1644 can facilitate communication between the app subnet(s) 1626 of the data plane mirror app tier 1640 and the app subnet(s) 1626 that can be contained in a data plane app tier 1646 (e.g., the data plane app tier 1546 of FIG. 15) via the VNIC 1642 contained in the data plane mirror app tier 1640 and the VNIC 1642 contained in the data plane app tier 1646.

The Internet gateway 1634 contained in the control plane VCN 1616 can be communicatively coupled to a metadata management service 1652 (e.g., the metadata management service 1552 of FIG. 15) that can be communicatively coupled to public Internet 1654 (e.g., public Internet 1554 of FIG. 15). Public Internet 1654 can be communicatively coupled to the NAT gateway 1638 contained in the control plane VCN 1616. The service gateway 1636 contained in the control plane VCN 1616 can be communicatively coupled to cloud services 1656 (e.g., cloud services 1556 of FIG. 15).

In some examples, the data plane VCN 1618 can be contained in the customer tenancy 1621. In this case, the IaaS provider may provide the control plane VCN 1616 for each customer, and the IaaS provider may, for each customer, set up a unique compute instance 1644 that is contained in the service tenancy 1619. Each compute instance 1644 may allow communication between the control plane VCN 1616, contained in the service tenancy 1619, and the data plane VCN 1618 that is contained in the customer tenancy 1621. The compute instance 1644 may allow resources, that are provisioned in the control plane VCN 1616 that is contained in the service tenancy 1619, to be deployed or otherwise used in the data plane VCN 1618 that is contained in the customer tenancy 1621.

In other examples, the customer of the IaaS provider may have databases that live in the customer tenancy 1621. In this example, the control plane VCN 1616 can include the data plane mirror app tier 1640 that can include app subnet(s) 1626. The data plane mirror app tier 1640 can reside in the data plane VCN 1618, but the data plane mirror app tier 1640 may not live in the data plane VCN 1618. That is, the data plane mirror app tier 1640 may have access to the customer tenancy 1621, but the data plane mirror app tier 1640 may not exist in the data plane VCN 1618 or be owned or operated by the customer of the IaaS provider. The data plane mirror app tier 1640 may be configured to make calls to the data plane VCN 1618 but may not be configured to make calls to any entity contained in the control plane VCN 1616. The customer may desire to deploy or otherwise use resources in the data plane VCN 1618 that are provisioned in the control plane VCN 1616, and the data plane mirror app tier 1640 can facilitate the desired deployment, or other usage of resources, of the customer.

In some embodiments, the customer of the IaaS provider can apply filters to the data plane VCN 1618. In this embodiment, the customer can determine what the data plane VCN 1618 can access, and the customer may restrict access to public Internet 1654 from the data plane VCN 1618. The IaaS provider may not be able to apply filters or otherwise control access of the data plane VCN 1618 to any outside networks or databases. Applying filters and controls by the customer onto the data plane VCN 1618, contained in the customer tenancy 1621, can help isolate the data plane VCN 1618 from other customers and from public Internet 1654.

In some embodiments, cloud services 1656 can be called by the service gateway 1636 to access services that may not exist on public Internet 1654, on the control plane VCN 1616, or on the data plane VCN 1618. The connection between cloud services 1656 and the control plane VCN 1616 or the data plane VCN 1618 may not be live or continuous. Cloud services 1656 may exist on a different network owned or operated by the IaaS provider. Cloud services 1656 may be configured to receive calls from the service gateway 1636 and may be configured to not receive calls from public Internet 1654. Some cloud services 1656 may be isolated from other cloud services 1656, and the control plane VCN 1616 may be isolated from cloud services 1656 that may not be in the same region as the control plane VCN 1616. For example, the control plane VCN 1616 may be located in “Region 1,” and cloud service “Deployment 15,” may be located in Region 1 and in “Region 2.” If a call to Deployment 15 is made by the service gateway 1636 contained in the control plane VCN 1616 located in Region 1, the call may be transmitted to Deployment 15 in Region 1. In this example, the control plane VCN 1616, or Deployment 15 in Region 1, may not be communicatively coupled to, or otherwise in communication with, Deployment 15 in Region 2.

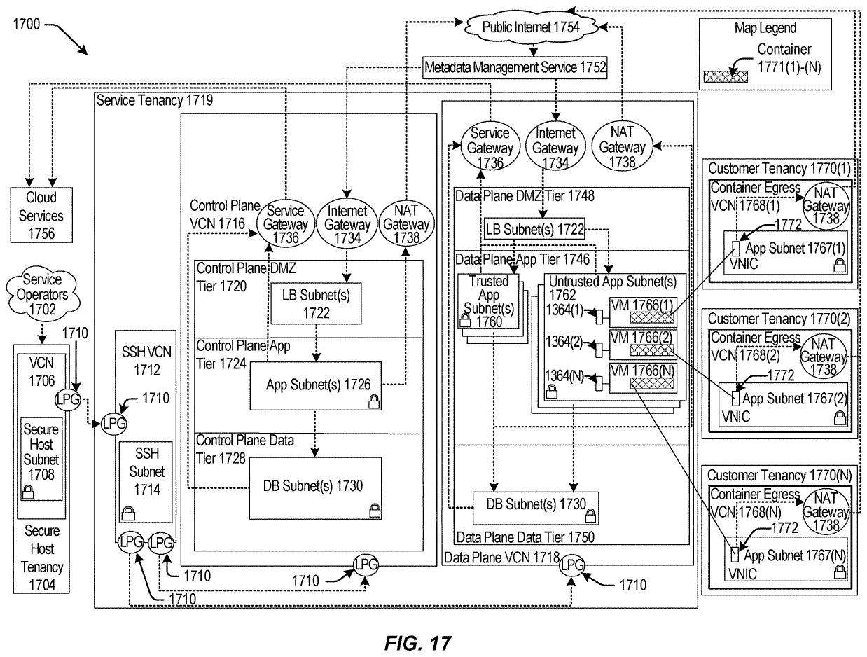

FIG. 17 is a block diagram 1700 illustrating another example pattern of an IaaS architecture, according to at least one embodiment. Service operators 1702 (e.g., service operators 1502 of FIG. 15) can be communicatively coupled to a secure host tenancy 1704 (e.g., the secure host tenancy 1504 of FIG. 15) that can include a virtual cloud network (VCN) 1706 (e.g., the VCN 1506 of FIG. 15) and a secure host subnet 1708 (e.g., the secure host subnet 1508 of FIG. 15). The VCN 1706 can include an LPG 1710 (e.g., the LPG 1510 of FIG. 15) that can be communicatively coupled to an SSH VCN 1712 (e.g., the SSH VCN 1512 of FIG. 15) via an LPG 1710 contained in the SSH VCN 1712. The SSH VCN 1712 can include an SSH subnet 1714 (e.g., the SSH subnet 1514 of FIG. 15), and the SSH VCN 1712 can be communicatively coupled to a control plane VCN 1716 (e.g., the control plane VCN 1516 of FIG. 15) via an LPG 1710 contained in the control plane VCN 1716 and to a data plane VCN 1718 (e.g., the data plane 1518 of FIG. 15) via an LPG 1710 contained in the data plane VCN 1718. The control plane VCN 1716 and the data plane VCN 1718 can be contained in a service tenancy 1719 (e.g., the service tenancy 1519 of FIG. 15).

The control plane VCN 1716 can include a control plane DMZ tier 1720 (e.g., the control plane DMZ tier 1520 of FIG. 15) that can include load balancer (LB) subnet(s) 1722 (e.g., LB subnet(s) 1522 of FIG. 15), a control plane app tier 1724 (e.g., the control plane app tier 1524 of FIG. 15) that can include app subnet(s) 1726 (e.g., similar to app subnet(s) 1526 of FIG. 15), a control plane data tier 1728 (e.g., the control plane data tier 1528 of FIG. 15) that can include DB subnet(s) 1730. The LB subnet(s) 1722 contained in the control plane DMZ tier 1720 can be communicatively coupled to the app subnet(s) 1726 contained in the control plane app tier 1724 and to an Internet gateway 1734 (e.g., the Internet gateway 1534 of FIG. 15) that can be contained in the control plane VCN 1716, and the app subnet(s) 1726 can be communicatively coupled to the DB subnet(s) 1730 contained in the control plane data tier 1728 and to a service gateway 1736 (e.g., the service gateway of FIG. 15) and a network address translation (NAT) gateway 1738 (e.g., the NAT gateway 1538 of FIG. 15). The control plane VCN 1716 can include the service gateway 1736 and the NAT gateway 1738.

The data plane VCN 1718 can include a data plane app tier 1746 (e.g., the data plane app tier 1546 of FIG. 15), a data plane DMZ tier 1748 (e.g., the data plane DMZ tier 1548 of FIG. 15), and a data plane data tier 1750 (e.g., the data plane data tier 1550 of FIG. 15). The data plane DMZ tier 1748 can include LB subnet(s) 1722 that can be communicatively coupled to trusted app subnet(s) 1760 and untrusted app subnet(s) 1762 of the data plane app tier 1746 and the Internet gateway 1734 contained in the data plane VCN 1718. The trusted app subnet(s) 1760 can be communicatively coupled to the service gateway 1736 contained in the data plane VCN 1718, the NAT gateway 1738 contained in the data plane VCN 1718, and DB subnet(s) 1730 contained in the data plane data tier 1750. The untrusted app subnet(s) 1762 can be communicatively coupled to the service gateway 1736 contained in the data plane VCN 1718 and DB subnet(s) 1730 contained in the data plane data tier 1750. The data plane data tier 1750 can include DB subnet(s) 1730 that can be communicatively coupled to the service gateway 1736 contained in the data plane VCN 1718.

The untrusted app subnet(s) 1762 can include one or more primary VNICs 1764(1)-(N) that can be communicatively coupled to tenant virtual machines (VMs) 1766(1)-(N). Each tenant VM 1766(1)-(N) can be communicatively coupled to a respective app subnet 1767(1)-(N) that can be contained in respective container egress VCNs 1768(1)-(N) that can be contained in respective customer tenancies 1770(1)-(N). Respective secondary VNICs 1772(1)-(N) can facilitate communication between the untrusted app subnet(s) 1762 contained in the data plane VCN 1718 and the app subnet contained in the container egress VCNs 1768(1)-(N). Each container egress VCNs 1768(1)-(N) can include a NAT gateway 1738 that can be communicatively coupled to public Internet 1754 (e.g., public Internet 1554 of FIG. 15).

The Internet gateway 1734 contained in the control plane VCN 1716 and contained in the data plane VCN 1718 can be communicatively coupled to a metadata management service 1752 (e.g., the metadata management system 1552 of FIG. 15) that can be communicatively coupled to public Internet 1754. Public Internet 1754 can be communicatively coupled to the NAT gateway 1738 contained in the control plane VCN 1716 and contained in the data plane VCN 1718. The service gateway 1736 contained in the control plane VCN 1716 and contained in the data plane VCN 1718 can be communicatively coupled to cloud services 1756.

In some embodiments, the data plane VCN 1718 can be integrated with customer tenancies 1770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1746. Code to run the function may be executed in the VMs 1766(1)-(N), and the code may not be configured to run anywhere else on the data plane VCN 1718. Each VM 1766(1)-(N) may be connected to one customer tenancy 1770. Respective containers 1771(1)-(N) contained in the VMs 1766(1)-(N) may be configured to run the code. In this case, there can be a dual isolation (e.g., the containers 1771(1)-(N) running code, where the containers 1771(1)-(N) may be contained in at least the VM 1766(1)-(N) that are contained in the untrusted app subnet(s) 1762), which may help prevent incorrect or otherwise undesirable code from damaging the network of the IaaS provider or from damaging a network of a different customer. The containers 1771(1)-(N) may be communicatively coupled to the customer tenancy 1770 and may be configured to transmit or receive data from the customer tenancy 1770. The containers 1771(1)-(N) may not be configured to transmit or receive data from any other entity in the data plane VCN 1718. Upon completion of running the code, the IaaS provider may kill or otherwise dispose of the containers 1771(1)-(N).

In some embodiments, the trusted app subnet(s) 1760 may run code that may be owned or operated by the IaaS provider. In this embodiment, the trusted app subnet(s) 1760 may be communicatively coupled to the DB subnet(s) 1730 and be configured to execute CRUD operations in the DB subnet(s) 1730. The untrusted app subnet(s) 1762 may be communicatively coupled to the DB subnet(s) 1730, but in this embodiment, the untrusted app subnet(s) may be configured to execute read operations in the DB subnet(s) 1730. The containers 1771(1)-(N) that can be contained in the VM 1766(1)-(N) of each customer and that may run code from the customer may not be communicatively coupled with the DB subnet(s) 1730.

In other embodiments, the control plane VCN 1716 and the data plane VCN 1718 may not be directly communicatively coupled. In this embodiment, there may be no direct communication between the control plane VCN 1716 and the data plane VCN 1718. However, communication can occur indirectly through at least one method. An LPG 1710 may be established by the IaaS provider that can facilitate communication between the control plane VCN 1716 and the data plane VCN 1718. In another example, the control plane VCN 1716 or the data plane VCN 1718 can make a call to cloud services 1756 via the service gateway 1736. For example, a call to cloud services 1756 from the control plane VCN 1716 can include a request for a service that can communicate with the data plane VCN 1718.

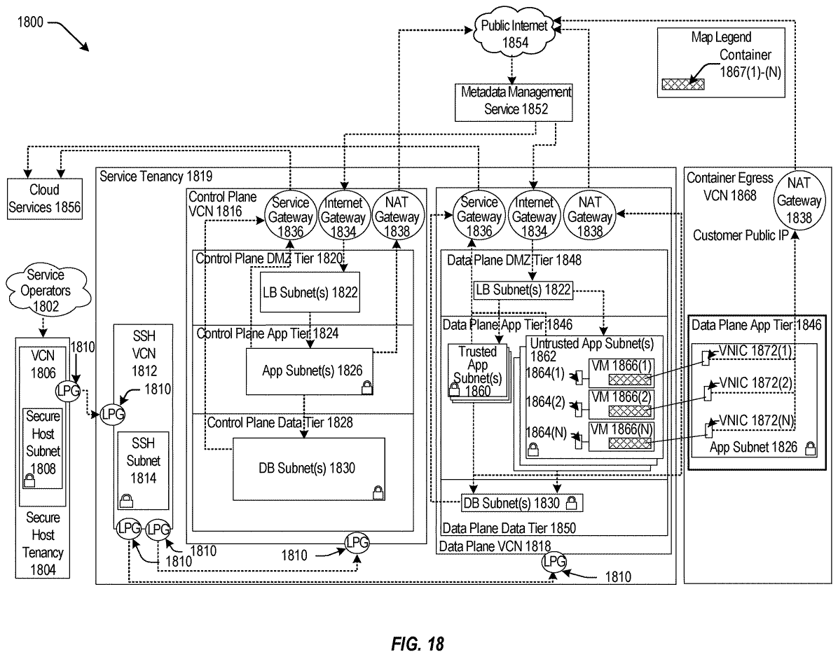

FIG. 18 is a block diagram 1800 illustrating another example pattern of an IaaS architecture, according to at least one embodiment. Service operators 1802 (e.g., service operators 1502 of FIG. 15) can be communicatively coupled to a secure host tenancy 1804 (e.g., the secure host tenancy 1504 of FIG. 15) that can include a virtual cloud network (VCN) 1806 (e.g., the VCN 1506 of FIG. 15) and a secure host subnet 1808 (e.g., the secure host subnet 1508 of FIG. 15). The VCN 1806 can include an LPG 1810 (e.g., the LPG 1510 of FIG. 15) that can be communicatively coupled to an SSH VCN 1812 (e.g., the SSH VCN 1512 of FIG. 15) via an LPG 1810 contained in the SSH VCN 1812. The SSH VCN 1812 can include an SSH subnet 1814 (e.g., the SSH subnet 1514 of FIG. 15), and the SSH VCN 1812 can be communicatively coupled to a control plane VCN 1816 (e.g., the control plane VCN 1516 of FIG. 15) via an LPG 1810 contained in the control plane VCN 1816 and to a data plane VCN 1818 (e.g., the data plane 1518 of FIG. 15) via an LPG 1810 contained in the data plane VCN 1818. The control plane VCN 1816 and the data plane VCN 1818 can be contained in a service tenancy 1819 (e.g., the service tenancy 1519 of FIG. 15).

The control plane VCN 1816 can include a control plane DMZ tier 1820 (e.g., the control plane DMZ tier 1520 of FIG. 15) that can include LB subnet(s) 1822 (e.g., LB subnet(s) 1522 of FIG. 15), a control plane app tier 1824 (e.g., the control plane app tier 1524 of FIG. 15) that can include app subnet(s) 1826 (e.g., app subnet(s) 1526 of FIG. 15), a control plane data tier 1828 (e.g., the control plane data tier 1528 of FIG. 15) that can include DB subnet(s) 1830 (e.g., DB subnet(s) 1730 of FIG. 17). The LB subnet(s) 1822 contained in the control plane DMZ tier 1820 can be communicatively coupled to the app subnet(s) 1826 contained in the control plane app tier 1824 and to an Internet gateway 1834 (e.g., the Internet gateway 1534 of FIG. 15) that can be contained in the control plane VCN 1816, and the app subnet(s) 1826 can be communicatively coupled to the DB subnet(s) 1830 contained in the control plane data tier 1828 and to a service gateway 1836 (e.g., the service gateway of FIG. 15) and a network address translation (NAT) gateway 1838 (e.g., the NAT gateway 1538 of FIG. 15). The control plane VCN 1816 can include the service gateway 1836 and the NAT gateway 1838.

The data plane VCN 1818 can include a data plane app tier 1846 (e.g., the data plane app tier 1546 of FIG. 15), a data plane DMZ tier 1848 (e.g., the data plane DMZ tier 1548 of FIG. 15), and a data plane data tier 1850 (e.g., the data plane data tier 1550 of FIG. 15). The data plane DMZ tier 1848 can include LB subnet(s) 1822 that can be communicatively coupled to trusted app subnet(s) 1860 (e.g., trusted app subnet(s) 1760 of FIG. 17) and untrusted app subnet(s) 1862 (e.g., untrusted app subnet(s) 1762 of FIG. 17) of the data plane app tier 1846 and the Internet gateway 1834 contained in the data plane VCN 1818. The trusted app subnet(s) 1860 can be communicatively coupled to the service gateway 1836 contained in the data plane VCN 1818, the NAT gateway 1838 contained in the data plane VCN 1818, and DB subnet(s) 1830 contained in the data plane data tier 1850. The untrusted app subnet(s) 1862 can be communicatively coupled to the service gateway 1836 contained in the data plane VCN 1818 and DB subnet(s) 1830 contained in the data plane data tier 1850. The data plane data tier 1850 can include DB subnet(s) 1830 that can be communicatively coupled to the service gateway 1836 contained in the data plane VCN 1818.

The untrusted app subnet(s) 1862 can include primary VNICs 1864(1)-(N) that can be communicatively coupled to tenant virtual machines (VMs) 1866(1)-(N) residing within the untrusted app subnet(s) 1862. Each tenant VM 1866(1)-(N) can run code in a respective container 1867(1)-(N), and be communicatively coupled to an app subnet 1826 that can be contained in a data plane app tier 1846 that can be contained in a container egress VCN 1868. Respective secondary VNICs 1872(1)-(N) can facilitate communication between the untrusted app subnet(s) 1862 contained in the data plane VCN 1818 and the app subnet contained in the container egress VCN 1868. The container egress VCN can include a NAT gateway 1838 that can be communicatively coupled to public Internet 1854 (e.g., public Internet 1554 of FIG. 15).

The Internet gateway 1834 contained in the control plane VCN 1816 and contained in the data plane VCN 1818 can be communicatively coupled to a metadata management service 1852 (e.g., the metadata management system 1552 of FIG. 15) that can be communicatively coupled to public Internet 1854. Public Internet 1854 can be communicatively coupled to the NAT gateway 1838 contained in the control plane VCN 1816 and contained in the data plane VCN 1818. The service gateway 1836 contained in the control plane VCN 1816 and contained in the data plane VCN 1818 can be communicatively coupled to cloud services 1856.

In some examples, the pattern illustrated by the architecture of block diagram 1800 of FIG. 18 may be considered an exception to the pattern illustrated by the architecture of block diagram 1700 of FIG. 17 and may be desirable for a customer of the IaaS provider if the IaaS provider cannot directly communicate with the customer (e.g., a disconnected region). The respective containers 1867(1)-(N) that are contained in the VMs 1866(1)-(N) for each customer can be accessed in real-time by the customer. The containers 1867(1)-(N) may be configured to make calls to respective secondary VNICs 1872(1)-(N) contained in app subnet(s) 1826 of the data plane app tier 1846 that can be contained in the container egress VCN 1868. The secondary VNICs 1872(1)-(N) can transmit the calls to the NAT gateway 1838 that may transmit the calls to public Internet 1854. In this example, the containers 1867(1)-(N) that can be accessed in real-time by the customer can be isolated from the control plane VCN 1816 and can be isolated from other entities contained in the data plane VCN 1818. The containers 1867(1)-(N) may also be isolated from resources from other customers.

In other examples, the customer can use the containers 1867(1)-(N) to call cloud services 1856. In this example, the customer may run code in the containers 1867(1)-(N) that requests a service from cloud services 1856. The containers 1867(1)-(N) can transmit this request to the secondary VNICs 1872(1)-(N) that can transmit the request to the NAT gateway that can transmit the request to public Internet 1854. Public Internet 1854 can transmit the request to LB subnet(s) 1822 contained in the control plane VCN 1816 via the Internet gateway 1834. In response to determining the request is valid, the LB subnet(s) can transmit the request to app subnet(s) 1826 that can transmit the request to cloud services 1856 via the service gateway 1836.

It should be appreciated that IaaS architectures 1500, 1600, 1700, 1800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

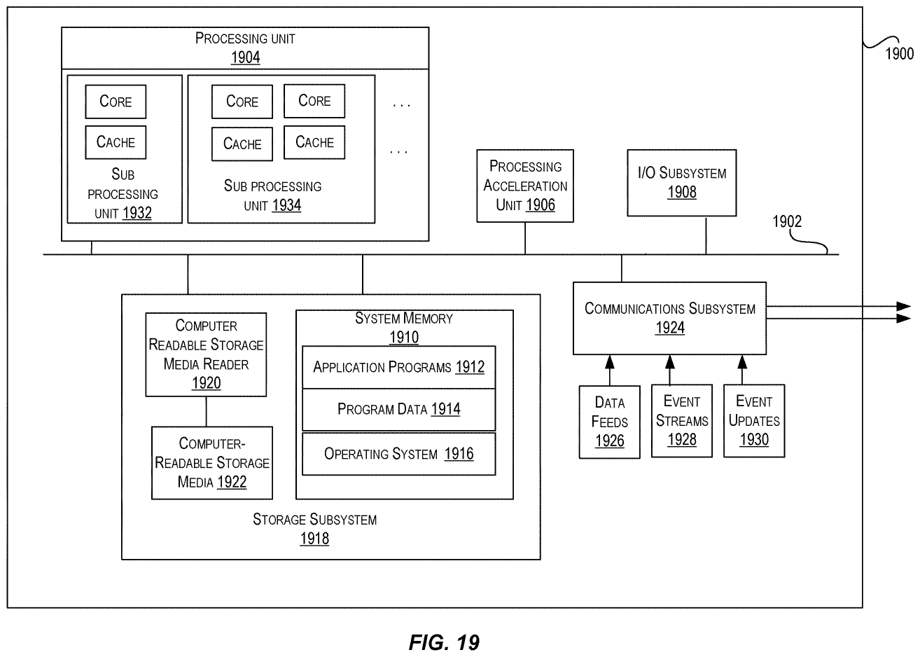

FIG. 19 illustrates an example computer system 1900, in which various embodiments may be implemented. The system 1900 may be used to implement any of the computer systems described above. As shown in the figure, computer system 1900 includes a processing unit 1904 that communicates with a number of peripheral subsystems via a bus subsystem 1902. These peripheral subsystems may include a processing acceleration unit 1906, an I/O subsystem 1908, a storage subsystem 1918 and a communications subsystem 1924. Storage subsystem 1918 includes tangible computer-readable storage media 1922 and a system memory 1910.

Bus subsystem 1902 provides a mechanism for letting the various components and subsystems of computer system 1900 communicate with each other as intended. Although bus subsystem 1902 is shown schematically as a single bus, alternative embodiments of the bus subsystem may utilize multiple buses. Bus subsystem 1902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1904, which can be implemented as one or more integrated circuits (e.g., a conventional microprocessor or microcontroller), controls the operation of computer system 1900. One or more processors may be included in processing unit 1904. These processors may include single core or multicore processors. In certain embodiments, processing unit 1904 may be implemented as one or more independent processing units 1932 and/or 1934 with single or multicore processors included in each processing unit. In other embodiments, processing unit 1904 may also be implemented as a quad-core processing unit formed by integrating two dual-core processors into a single chip.

In various embodiments, processing unit 1904 can execute a variety of programs in response to program code and can maintain multiple concurrently executing programs or processes. At any given time, some or all of the program code to be executed can be resident in processor(s) 1904 and/or in storage subsystem 1918. Through suitable programming, processor(s) 1904 can provide various functionalities described above. Computer system 1900 may additionally include a processing acceleration unit 1906, which can include a digital signal processor (DSP), a special-purpose processor, and/or the like.

I/O subsystem 1908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1900 may comprise a storage subsystem 1918 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1904 provide the functionality described above. Storage subsystem 1918 may also provide a repository for storing data used in accordance with the present disclosure.

As depicted in the example in FIG. 19, storage subsystem 1918 can include various components including a system memory 1910, computer-readable storage media 1922, and a computer readable storage media reader 1920. System memory 1910 may store program instructions that are loadable and executable by processing unit 1904. System memory 1910 may also store data that is used during the execution of the instructions and/or data that is generated during the execution of the program instructions. Various different kinds of programs may be loaded into system memory 1910 including but not limited to client applications, Web browsers, mid-tier applications, relational database management systems (RDBMS), virtual machines, containers, etc.

System memory 1910 may also store an operating system 1916. Examples of operating system 1916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1900 executes one or more virtual machines, the virtual machines along with their guest operating systems (GOSs) may be loaded into system memory 1910 and executed by one or more processors or cores of processing unit 1904.

System memory 1910 can come in different configurations depending upon the type of computer system 1900. For example, system memory 1910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1910 may include a basic input/output system (BIOS) containing basic routines that help to transfer information between elements within computer system 1900, such as during start-up.

Computer-readable storage media 1922 may represent remote, local, fixed, and/or removable storage devices plus storage media for temporarily and/or more permanently containing, storing, computer-readable information for use by computer system 1900 including instructions executable by processing unit 1904 of computer system 1900.

Computer-readable storage media 1922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1922 may include, but is not limited to, Zip® drives, flash memory cards, universal serial bus (USB) flash drives, secure digital (SD) cards, DVD disks, digital video tape, and the like. Computer-readable storage media 1922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1900.

Machine-readable instructions executable by one or more processors or cores of processing unit 1904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1924 provides an interface to other computer systems and networks. Communications subsystem 1924 serves as an interface for receiving data from and transmitting data to other systems from computer system 1900. For example, communications subsystem 1924 may enable computer system 1900 to connect to one or more devices via the Internet. In some embodiments communications subsystem 1924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1924 can provide wired network connectivity (e.g., Ethernet) in addition to or instead of a wireless interface.

In some embodiments, communications subsystem 1924 may also receive input communication in the form of structured and/or unstructured data feeds 1926, event streams 1928, event updates 1930, and the like on behalf of one or more users who may use computer system 1900.

By way of example, communications subsystem 1924 may be configured to receive data feeds 1926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1924 may also be configured to receive data in the form of continuous data streams, which may include event streams 1928 of real-time events and/or event updates 1930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1924 may also be configured to output the structured and/or unstructured data feeds 1926, event streams 1928, event updates 1930, and the like to one or more databases that may be in communication with one or more streaming data source computers coupled to computer system 1900.

Computer system 1900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving, at a source network virtualization device (NVD), a data packet destined for a cloud service accessible via a virtual IP address in a virtual cloud network (VCN);
encapsulating, by the source NVD, the data packet with a first encapsulation header to generate a first encapsulated data packet, the first encapsulated data packet being forwarded to a dynamic routing gateway (DRG);
encapsulating, by the DRG, the first encapsulated data packet with a second encapsulation header to generate a second encapsulated data packet, the second encapsulated data packet being forwarded to destination NVD associated with the cloud service;
decapsulating, by the destination NVD, the second encapsulated data packet to obtain the first encapsulated data packet; and
communicating, by the destination NVD, the first encapsulated data packet to the cloud service, wherein a virtual network interface card (VNIC) associated with the cloud service decapsulates the first encapsulated data packet to obtain the data packet.

2. The method of claim 1, wherein the source NVD receives the data packet from a compute instance associated with a customer, wherein the compute instance and the source NVD are included in a substrate network and the cloud service provided in the VCN is included in an overlay network.

3. The method of claim 1, wherein the first encapsulation header comprises information including at least a first substrate IP address of the source NVD and a virtual IP address of the VNIC associated with the cloud service.

4. The method of claim 3, wherein the second encapsulation header comprises information including at least a second substrate IP address of the destination NVD and the first substrate IP address of the source NVD.

5. The method of claim 1, wherein the destination NVD decapsulates the second encapsulated data packet by removing the second encapsulation header from the second encapsulated data packet to obtain the first encapsulated data packet.

6. The method of claim 2, wherein the VNIC associated with the cloud service decapsulates the first encapsulated data packet by removing the first encapsulation header from the first encapsulated data packet to obtain the data packet transmitted by the compute instance.

7. The method of claim 2, wherein the overlay network comprises a plurality of VCNs, each VCN of the plurality of VCNs being assigned a unique CIDR address, and wherein a subset of the plurality of VCNs are permitted to communicate with one or more endpoints in a substrate network.

8. The method of claim 7, wherein the endpoint in the substrate network corresponds to one of an integrated lights out management endpoint, a bastion server, or a network timing server endpoint.

9. The method of claim 2, wherein the cloud service provided in the VCN communicates directly with other services provided in the overlay network via a service gateway, and wherein the cloud service provided in the VCN communicates with a service platform and a plurality of endpoints included in the substrate network via the DRG.

10. A non-transitory computer readable medium storing specific computer-executable instructions that, when executed by a processor, cause a computer system to perform operations comprising:
receiving, at a source network virtualization device (NVD), a data packet destined for a cloud service accessible via a virtual IP address in a virtual cloud network (VCN);
encapsulating, by the source NVD, the data packet with a first encapsulation header to generate a first encapsulated data packet, the first encapsulated data packet being forwarded to a dynamic routing gateway (DRG);
encapsulating, by the DRG, the first encapsulated data packet with a second encapsulation header to generate a second encapsulated data packet, the second encapsulated data packet being forwarded to destination NVD associated with the cloud service;
decapsulating, by the destination NVD, the second encapsulated data packet to obtain the first encapsulated data packet; and
communicating, by the destination NVD, the first encapsulated data packet to the cloud service, wherein a virtual network interface card (VNIC) associated with the cloud service decapsulates the first encapsulated data packet to obtain the data packet.

11. The non-transitory computer readable medium storing specific computer-executable instructions of claim 10, wherein the source NVD receives the data packet from a compute instance associated with a customer, wherein the compute instance and the source NVD are included in a substrate network and the cloud service provided in the VCN is included in an overlay network.

12. The non-transitory computer readable medium storing specific computer-executable instructions of claim 10, wherein the first encapsulation header comprises information including at least a first substrate IP address of the source NVD and a virtual IP address of the VNIC associated with the cloud service.

13. The non-transitory computer readable medium storing specific computer-executable instructions of claim 12, wherein the second encapsulation header comprises information including at least a second substrate IP address of the destination NVD and the first substrate IP address of the source NVD.

14. The non-transitory computer readable medium storing specific computer-executable instructions of claim 10, wherein the destination NVD decapsulates the second encapsulated data packet by removing the second encapsulation header from the second encapsulated data packet to obtain the first encapsulated data packet.

15. The non-transitory computer readable medium storing specific computer-executable instructions of claim 11, wherein the VNIC associated with the cloud service decapsulates the first encapsulated data packet by removing the first encapsulation header from the first encapsulated data packet to obtain the data packet transmitted by the compute instance.

16. The non-transitory computer readable medium storing specific computer-executable instructions of claim 11, wherein the overlay network comprises a plurality of VCNs, each VCN of the plurality of VCNs being assigned a unique CIDR address, and wherein a subset of the plurality of VCNs are permitted to communicate with one or more endpoints in a substrate network.

17. The non-transitory computer readable medium storing specific computer-executable instructions of claim 16, wherein the endpoint in the substrate network corresponds to one of an integrated lights out management endpoint, a bastion server, or a network timing server endpoint.

18. The non-transitory computer readable medium storing specific computer-executable instructions of claim 11, wherein the cloud service provided in the VCN communicates directly with other services provided in the overlay network via a service gateway, and wherein the cloud service provided in the VCN communicates with a service platform and a plurality of endpoints included in the substrate network via the DRG.

19. A networking system comprising:
a processor; and
a memory including instructions that, when executed with the processor, cause the networking system to, at least:
receive, at a source network virtualization device (NVD), a data packet destined 117 for a cloud service accessible via a virtual IP address in a virtual cloud network (VCN);
encapsulate, by the source NVD, the data packet with a first encapsulation header to generate a first encapsulated data packet, the first encapsulated data packet being forwarded to a dynamic routing gateway (DRG);
encapsulate, by the DRG, the first encapsulated data packet with a second encapsulation header to generate a second encapsulated data packet, the second encapsulated data packet being forwarded to destination NVD associated with the cloud service;
decapsulate, by the destination NVD, the second encapsulated data packet to obtain the first encapsulated data packet; and
communicate, by the destination NVD, the first encapsulated data packet to the cloud service, wherein a virtual network interface card (VNIC) associated with the cloud service decapsulates the first encapsulated data packet to obtain the data packet.
wherein the source NVD receives the data packet from a compute instance associated with a customer, wherein the compute instance and the source NVD are included in a substrate network and the cloud service provided in the VCN is included in an overlay network.

20. The networking system of claim 19, wherein
the first encapsulation header comprises information including at least a first substrate IP address of the source NVD and a virtual IP address of the VNIC associated with the cloud 137 service, and
the second encapsulation header comprises information including at least a second substrate IP address of the destination NVD and the first substrate IP address of the source NVD.
